(19) United States
(12) Patent Application Publication
(10) Pub. No.: US 2026/0012617 A1
(43) Pub. Date: Jan. 8, 2026

(54) MODE DERIVATION FOR NEURAL NETWORK BASED INTRA PREDICTION FOR VIDEO CODING

(71) Applicant: QUALCOMM Incorporated, San Diego, CA (US)

(72) Inventors: Patrick Garus, München (DE); Pavel Nikitin, Moosining (DE); Samuel James Eadie, München (DE); Thomas Alexander Ryder, San Diego, CA (US); Muhammed Zeyd Coban, Carlsbad, CA (US); Vadim Seregin, San Diego, CA (US); Marta Karczewicz, San Diego, CA (US)

(21) Appl. No.: 19/231,991

(22) Filed: Jun. 9, 2025

Related U.S. Application Data
(60) Provisional application No. 63/668,095, filed on Jul. 5, 2024.

(51) Int. Cl. H04N 19/176; H04N 19/12; H04N 19/159; H04N 19/61

(52) U.S. Cl. CPC H04N 19/176; H04N 19/12; H04N 19/159; H04N 19/61

(57) ABSTRACT

An example device for decoding video data includes a memory configured to store video data; and a processing system comprising one or more processors implemented in circuitry, the processing system being configured to: generate a prediction block for a current block of video data using a neural network; determine an equivalent intra mode for the prediction block from a set of available intra-prediction modes using decoder-side intra mode derivation (DIMD), the equivalent intra mode representing one of the intra-prediction modes that would generate an intra-prediction block that would best match the prediction block generated using the neural network; decode a residual block for the current block of the video data based on the equivalent intra mode; and combine the prediction block with the residual block to decode the current block of the video data.

This application claims the benefit of U.S. Provisional Application No. 63/668,095, filed Jul. 5, 2024, the entire contents of which are hereby incorporated by reference.

### TECHNICAL FIELD

This disclosure relates to video coding, including video encoding and video decoding.

### BACKGROUND

Digital video capabilities can be incorporated into a wide range of devices, including digital televisions, digital direct broadcast systems, wireless broadcast systems, personal digital assistants (PDAs), laptop or desktop computers, tablet computers, e-book readers, digital cameras, digital recording devices, digital media players, video gaming devices, video game consoles, cellular or satellite radio telephones, so-called “smart phones,” video teleconferencing devices, video streaming devices, and the like. Digital video devices implement video coding techniques, such as those described in the standards defined by MPEG-2, MPEG-4, ITU-T H.263, ITU-T H.264/MPEG-4, Part 10, Advanced Video Coding (AVC), ITU-T H.265/High Efficiency Video Coding (HEVC), ITU-T H.266/Versatile Video Coding (VVC), and extensions of such standards, as well as proprietary video codecs/formats such as AOMedia Video 1 (AV1) developed by the Alliance for Open Media. The video devices may transmit, receive, encode, decode, and/or store digital video information more efficiently by implementing such video coding techniques.

Video coding techniques include spatial (intra-picture) prediction and/or temporal (inter-picture) prediction to reduce or remove redundancy inherent in video sequences. For block-based video coding, a video slice (e.g., a video picture or a portion of a video picture) may be partitioned into video blocks, which may also be referred to as coding tree units (CTUs), coding units (CUs) and/or coding nodes. Video blocks in an intra-coded (I) slice of a picture are encoded using spatial prediction with respect to reference samples in neighboring blocks in the same picture. Video blocks in an inter-coded (P or B) slice of a picture may use spatial prediction with respect to reference samples in neighboring blocks in the same picture or temporal prediction with respect to reference samples in other reference pictures. Pictures may be referred to as frames, and reference pictures may be referred to as reference frames.

### SUMMARY

In general, this disclosure describes techniques for encoding and decoding video data. Video coding generally includes generating a prediction block and coding (encoding or decoding) a residual block representing sample-by-sample differences between the prediction block and an uncoded block. Encoding may include calculating the residual block using the prediction block and then encoding the residual block, whereas decoding may include decoding the residual block and combining the residual block with the prediction block. In some cases, coding the residual block may include selecting a transform to apply during coding of the residual block based on an intra-prediction mode used to form the prediction block. However, this disclosure is directed to using a neural network or other artificial intelligence/machine learning (AI/ML) model to generate the prediction block, in which case a conventional intra-prediction mode is not determined. Therefore, this disclosure describes techniques for deriving an equivalent intra prediction mode, e.g., using decoder-side intra mode derivation (DIMD), that represents an intra-prediction mode of a set of available intra-prediction modes that would have generated an intra-prediction block that best matches the prediction block generated by the neural network/AI/ML model. In this manner, the equivalent intra-prediction mode can be used to encode or decode the residual block, thereby improving performance of the video encoder and the video decoder.

In one example, a method of decoding video data includes: generating a prediction block for a current block of video data using a neural network; determining an equivalent intra mode for the prediction block from a set of available intra-prediction modes using decoder-side intra mode derivation (DIMD), the equivalent intra mode representing one of the intra-prediction modes that would generate an intra-prediction block that would best match the prediction block generated using the neural network; decoding a residual block for the current block of the video data based on the equivalent intra mode; and combining the prediction block with the residual block to decode the current block of the video data.

In another example, a device for decoding video data includes: a memory configured to store video data; and a processing system comprising one or more processors implemented in circuitry, the processing system being configured to: generate a prediction block for a current block of video data using a neural network; determine an equivalent intra mode for the prediction block from a set of available intra-prediction modes using decoder-side intra mode derivation (DIMD), the equivalent intra mode representing one of the intra-prediction modes that would generate an intra-prediction block that would best match the prediction block generated using the neural network; decode a residual block for the current block of the video data based on the equivalent intra mode; and combine the prediction block with the residual block to decode the current block of the video data.

In another example, a device for decoding video data includes: means for generating a prediction block for a current block of video data using a neural network; means for determining an equivalent intra mode for the prediction block from a set of available intra-prediction modes using decoder-side intra mode derivation (DIMD), the equivalent intra mode representing one of the intra-prediction modes that would generate an intra-prediction block that would best match the prediction block generated using the neural network; means for decoding a residual block for the current block of the video data based on the equivalent intra mode; and means for combining the prediction block with the residual block to decode the current block of the video data.

In another example, a non-transitory computer-readable storage medium has stored thereon instructions that, when executed, cause a processor to: generate a prediction block for a current block of video data using a neural network; determine an equivalent intra mode for the prediction block from a set of available intra-prediction modes using decoder-side intra mode derivation (DIMD), the equivalent intra mode representing one of the intra-prediction modes that would generate an intra-prediction block that would best match the prediction block generated using the neural network; decode a residual block for the current block of the video data based on the equivalent intra mode; and combine the prediction block with the residual block to decode the current block of the video data.

The details of one or more examples are set forth in the accompanying drawings and the description below. Other features, objects, and advantages will be apparent from the description, drawings, and claims.

### BRIEF DESCRIPTION OF THE DRAWINGS

FIG. 1 is a block diagram illustrating an example video encoding and decoding system that may perform the techniques of this disclosure.

FIG. 2 is a conceptual diagram illustrating various example intra prediction modes.

FIG. 3 is a conceptual diagram illustrating prediction of a current block from a context of neighboring reference samples.

FIG. 4 is a block diagram illustrating an example video encoder that may perform the techniques of this disclosure.

FIG. 5 is a block diagram illustrating an example video decoder that may perform the techniques of this disclosure.

FIG. 6 is a flowchart illustrating an example method for encoding a current block in accordance with the techniques of this disclosure.

FIG. 7 is a flowchart illustrating an example method for decoding a current block in accordance with the techniques of this disclosure.

FIG. 8 is a block diagram illustrating another example of a video encoder per techniques of this disclosure.

FIG. 9 is a block diagram illustrating another example of a video decoder per techniques of this disclosure.

FIG. 10 is a flowchart illustrating an example method of decoding a block of video data according to techniques of this disclosure.

### DETAILED DESCRIPTION

Video coding standards include ITU-T H.261, ISO/IEC MPEG-1 Visual, ITU-T H.262 or ISO/IEC MPEG-2 Visual, ITU-T H.263, ISO/IEC MPEG-4 Visual (MPEG-4 Part 2), ITU-T H.264 (also known as ISO/IEC MPEG-4 AVC), including its Scalable Video Coding (SVC) and Multiview Video Coding (MVC) extensions, ITU-T H.265 (also known as ISO/IEC MPEG-4 HEVC) with its extensions, and ITU-T H.266/Versatile Video Coding (VVC).

JVET is exploring technologies to further improve coding performance, and an exploration activity has been established and a corresponding test model reference software is in process named enhanced compression model (ECM).

In general, this disclosure describes techniques for encoding and decoding video data. Video coding generally includes generating a prediction block and coding (encoding or decoding) a residual block representing sample-by-sample differences between the prediction block and an uncoded block. Encoding may include calculating the residual block using the prediction block and then encoding the residual block, whereas decoding may include decoding the residual block and combining the residual block with the prediction block. In some cases, coding the residual block may include selecting a transform to apply during coding of the residual block based on an intra-prediction mode used to form the prediction block. However, this disclosure is directed to using a neural network or other artificial intelligence/machine learning (AI/ML) model to generate the prediction block, in which case a conventional intra-prediction mode is not determined. Therefore, this disclosure describes techniques for deriving an equivalent intra prediction mode, e.g., using decoder-side intra mode derivation (DIMD), that represents an intra-prediction mode of a set of available intra-prediction modes that would have generated an intra-prediction block that best matches the prediction block generated by the neural network/AI/ML model. In this manner, the equivalent intra-prediction mode can be used to encode or decode the residual block, thereby improving performance of the video encoder and the video decoder.

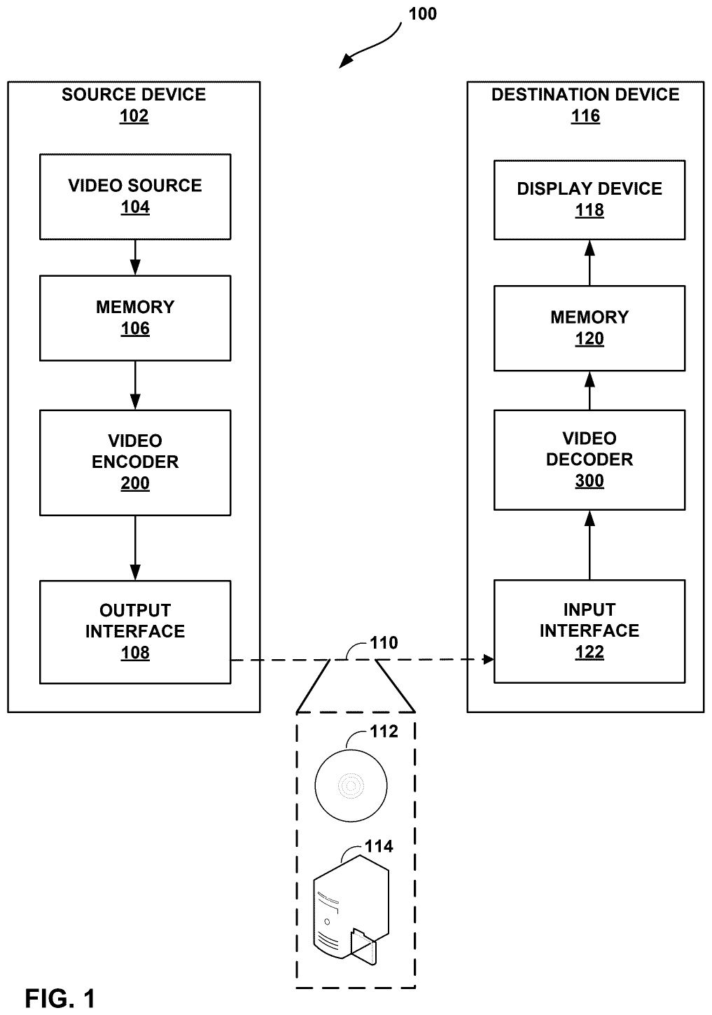

FIG. 1 is a block diagram illustrating an example video encoding and decoding system 100 that may perform the techniques of this disclosure. The techniques of this disclosure are generally directed to coding (encoding and/or decoding) video data. In general, video data includes any data for processing a video. Thus, video data may include raw, uncoded video, encoded video, decoded (e.g., reconstructed) video, and video metadata, such as signaling data.

As shown in FIG. 1, system 100 includes a source device 102 that provides encoded video data to be decoded and displayed by a destination device 116, in this example. In particular, source device 102 provides the video data to destination device 116 via a computer-readable medium 110. Source device 102 and destination device 116 may include any of a wide range of devices, such as desktop computers, notebook (i.e., laptop) computers, mobile devices, tablet computers, set-top boxes, telephone handsets such as smartphones, televisions, cameras, display devices, digital media players, video gaming consoles, video streaming device, broadcast receiver devices, or the like. In some cases, source device 102 and destination device 116 may be equipped for wireless communication, and thus may be referred to as wireless communication devices.

In the example of FIG. 1, source device 102 includes video source 104, memory 106, video encoder 200, and output interface 108. Destination device 116 includes input interface 122, video decoder 300, memory 120, and display device 118. In accordance with this disclosure, video encoder 200 of source device 102 and video decoder 300 of destination device 116 may be configured to apply the techniques for determining an equivalent intra prediction mode. Thus, source device 102 represents an example of a video encoding device, while destination device 116 represents an example of a video decoding device. In other examples, a source device and a destination device may include other components or arrangements. For example, source device 102 may receive video data from an external video source, such as an external camera. Likewise, destination device 116 may interface with an external display device, rather than include an integrated display device.

System 100 as shown in FIG. 1 is merely one example. In general, any digital video encoding and/or decoding device may perform techniques for determining an equivalent intra prediction mode. Source device 102 and destination device 116 are merely examples of such coding devices in which source device 102 generates coded video data for transmission to destination device 116. This disclosure refers to a “coding” device as a device that performs coding (encoding and/or decoding) of data. Thus, video encoder 200 and video decoder 300 represent examples of coding devices, in particular, a video encoder and a video decoder, respectively. In some examples, source device 102 and destination device 116 may operate in a substantially symmetrical manner such that each of source device 102 and destination device 116 includes video encoding and decoding components. Hence, system 100 may support one-way or two-way video transmission between source device 102 and destination device 116, e.g., for video streaming, video playback, video broadcasting, or video telephony.

In general, video source 104 represents a source of video data (i.e., raw, uncoded video data) and provides a sequential series of pictures (also referred to as “frames”) of the video data to video encoder 200, which encodes data for the pictures. Video source 104 of source device 102 may include a video capture device, such as a video camera, a video archive containing previously captured raw video, and/or a video feed interface to receive video from a video content provider. As a further alternative, video source 104 may generate computer graphics-based data as the source video, or a combination of live video, archived video, and computer generated video. In each case, video encoder 200 encodes the captured, pre-captured, or computer-generated video data. Video encoder 200 may rearrange the pictures from the received order (sometimes referred to as “display order”) into a coding order for coding. Video encoder 200 may generate a bitstream including encoded video data. Source device 102 may then output the encoded video data via output interface 108 onto computer-readable medium 110 for reception and/or retrieval by, e.g., input interface 122 of destination device 116.

Memory 106 of source device 102 and memory 120 of destination device 116 represent general purpose memories. In some examples, memories 106, 120 may store raw video data, e.g., raw video from video source 104 and raw, decoded video data from video decoder 300. Additionally or alternatively, memories 106, 120 may store software instructions executable by, e.g., video encoder 200 and video decoder 300, respectively. Although memory 106 and memory 120 are shown separately from video encoder 200 and video decoder 300 in this example, it should be understood that video encoder 200 and video decoder 300 may also include internal memories for functionally similar or equivalent purposes. Furthermore, memories 106, 120 may store encoded video data, e.g., output from video encoder 200 and input to video decoder 300. In some examples, portions of memories 106, 120 may be allocated as one or more video buffers, e.g., to store raw, decoded, and/or encoded video data.

Computer-readable medium 110 may represent any type of medium or device capable of transporting the encoded video data from source device 102 to destination device 116. In one example, computer-readable medium 110 represents a communication medium to enable source device 102 to transmit encoded video data directly to destination device 116 in real-time, e.g., via a radio frequency network or computer-based network. Output interface 108 may modulate a transmission signal including the encoded video data, and input interface 122 may demodulate the received transmission signal, according to a communication standard, such as a wireless communication protocol. The communication medium may include any wireless or wired communication medium, such as a radio frequency (RF) spectrum or one or more physical transmission lines. The communication medium may form part of a packet-based network, such as a local area network, a wide-area network, or a global network such as the Internet. The communication medium may include routers, switches, base stations, or any other equipment that may be useful to facilitate communication from source device 102 to destination device 116.

In some examples, source device 102 may output encoded data from output interface 108 to storage device 112. Similarly, destination device 116 may access encoded data from storage device 112 via input interface 122. Storage device 112 may include any of a variety of distributed or locally accessed data storage media such as a hard drive, Blu-ray discs, DVDs, CD-ROMs, flash memory, volatile or non-volatile memory, or any other suitable digital storage media for storing encoded video data.

In some examples, source device 102 may output encoded video data to file server 114 or another intermediate storage device that may store the encoded video data generated by source device 102. Destination device 116 may access stored video data from file server 114 via streaming or download.

File server 114 may be any type of server device capable of storing encoded video data and transmitting that encoded video data to the destination device 116. File server 114 may represent a web server (e.g., for a website), a server configured to provide a file transfer protocol service (such as File Transfer Protocol (FTP) or File Delivery over Unidirectional Transport (FLUTE) protocol), a content delivery network (CDN) device, a hypertext transfer protocol (HTTP) server, a Multimedia Broadcast Multicast Service (MBMS) or Enhanced MBMS (eMBMS) server, and/or a network attached storage (NAS) device. File server 114 may, additionally or alternatively, implement one or more HTTP streaming protocols, such as Dynamic Adaptive Streaming over HTTP (DASH), HTTP Live Streaming (HLS), Real Time Streaming Protocol (RTSP), HTTP Dynamic Streaming, or the like.

Destination device 116 may access encoded video data from file server 114 through any standard data connection, including an Internet connection. This may include a wireless channel (e.g., a Wi-Fi connection), a wired connection (e.g., digital subscriber line (DSL), cable modem, etc.), or a combination of both that is suitable for accessing encoded video data stored on file server 114. Input interface 122 may be configured to operate according to any one or more of the various protocols discussed above for retrieving or receiving media data from file server 114, or other such protocols for retrieving media data.

Output interface 108 and input interface 122 may represent wireless transmitters/receivers, modems, wired networking components (e.g., Ethernet cards), wireless communication components that operate according to any of a variety of IEEE 802.11 standards, or other physical components. In examples where output interface 108 and input interface 122 include wireless components, output interface 108 and input interface 122 may be configured to transfer data, such as encoded video data, according to a cellular communication standard, such as 4G, 4G-LTE (Long-Term Evolution), LTE Advanced, 5G, or the like. In some examples where output interface 108 includes a wireless transmitter, output interface 108 and input interface 122 may be configured to transfer data, such as encoded video data, according to other wireless standards, such as an IEEE 802.11 specification, an IEEE 802.15 specification (e.g., ZigBee™), a Bluetooth™ standard, or the like. In some examples, source device 102 and/or destination device 116 may include respective system-on-a-chip (SoC) devices. For example, source device 102 may include an SoC device to perform the functionality attributed to video encoder 200 and/or output interface 108, and destination device 116 may include an SoC device to perform the functionality attributed to video decoder 300 and/or input interface 122.

The techniques of this disclosure may be applied to video coding in support of any of a variety of multimedia applications, such as over-the-air television broadcasts, cable television transmissions, satellite television transmissions, Internet streaming video transmissions, such as dynamic adaptive streaming over HTTP (DASH), digital video that is encoded onto a data storage medium, decoding of digital video stored on a data storage medium, or other applications.

Input interface 122 of destination device 116 receives an encoded video bitstream from computer-readable medium 110 (e.g., a communication medium, storage device 112, file server 114, or the like). The encoded video bitstream may include signaling information defined by video encoder 200, which is also used by video decoder 300, such as syntax elements having values that describe characteristics and/or processing of video blocks or other coded units (e.g., slices, pictures, groups of pictures, sequences, or the like). Display device 118 displays decoded pictures of the decoded video data to a user. Display device 118 may represent any of a variety of display devices such as a liquid crystal display (LCD), a plasma display, an organic light emitting diode (OLED) display, or another type of display device.

Although not shown in FIG. 1, in some examples, video encoder 200 and video decoder 300 may each be integrated with an audio encoder and/or audio decoder, and may include appropriate MUX-DEMUX units, or other hardware and/or software, to handle multiplexed streams including both audio and video in a common data stream. Example audio codecs include AAC, AC-3, AC-4, ALAC, ALS, AMBE, AMR, AMR-WB (G.722.2), AMR-WB+, aptx (various versions), ATRAC, BroadVoice (BV16, BV32), CELT, Enhanced AC-3 (E-AC-3), EVS, FLAC, G.711, G.722, G.722.1, G.722.2 (AMR-WB), G.723.1, G.726, G.728, G.729, G.729.1, GSM-FR, HE-AAC, iLBC, iSAC, LA Lyra, Monkey's Audio, MP1, MP2 (MPEG-1, 2 Audio Layer II), MP3, Musepack, Nellymoser Asao, OptimFROG, Opus, Sac, Satin, SBC, SILK, Siren 7, Speex, SVOPC, True Audio (TTA), TwinVQ, USAC, Vorbis (Ogg), WavPack, and Windows Media Audio.

Video encoder 200 and video decoder 300 each may be implemented as any of a variety of suitable encoder and/or decoder circuitry of a processing system, such as one or more microprocessors, digital signal processors (DSPs), application specific integrated circuits (ASICs), field programmable gate arrays (FPGAs), discrete logic, software, hardware, firmware or any combinations thereof. When the techniques are implemented partially in software, a device may store instructions for the software in a suitable, non-transitory computer-readable medium and execute the instructions in hardware using one or more processors to perform the techniques of this disclosure. Each of video encoder 200 and video decoder 300 may be included in one or more encoders or decoders, either of which may be integrated as part of a combined encoder/decoder (CODEC) in a respective device. A device including video encoder 200 and/or video decoder 300 may include an integrated circuit, a microprocessor, and/or a wireless communication device, such as a cellular telephone, or any other type of device described herein.

Video encoder 200 and video decoder 300 may operate according to a video coding standard, such as ITU-T H.265, also referred to as High Efficiency Video Coding (HEVC) or extensions thereto, such as the multi-view and/or scalable video coding extensions. Alternatively, video encoder 200 and video decoder 300 may operate according to other proprietary or industry standards, such as ITU-T H.266, also referred to as Versatile Video Coding (VVC). In other examples, video encoder 200 and video decoder 300 may operate according to a proprietary video codec/format, such as AOMedia Video 1 (AV1), extensions of AV1, and/or successor versions of AV1 (e.g., AV2). In other examples, video encoder 200 and video decoder 300 may operate according to other proprietary formats or industry standards. The techniques of this disclosure, however, are not limited to any particular coding standard or format. In general, video encoder 200 and video decoder 300 may be configured to perform the techniques of this disclosure in conjunction with any video coding techniques that use determination of an equivalent intra prediction mode.

In general, video encoder 200 and video decoder 300 may perform block-based coding of pictures. The term “block” generally refers to a structure including data to be processed (e.g., encoded, decoded, or otherwise used in the encoding and/or decoding process). For example, a block may include a two-dimensional matrix of samples of luminance and/or chrominance data. In general, video encoder 200 and video decoder 300 may code video data represented in a YUV (e.g., Y, Cb, Cr) format. That is, rather than coding red, green, and blue (RGB) data for samples of a picture, video encoder 200 and video decoder 300 may code luminance and chrominance components, where the chrominance components may include both red hue and blue hue chrominance components. In some examples, video encoder 200 converts received RGB formatted data to a YUV representation prior to encoding, and video decoder 300 converts the YUV representation to the RGB format. Alternatively, pre- and post-processing units (not shown) may perform these conversions.

This disclosure may generally refer to coding (e.g., encoding and decoding) of pictures to include the process of encoding or decoding data of the picture. Similarly, this disclosure may refer to coding of blocks of a picture to include the process of encoding or decoding data for the blocks, e.g., prediction and/or residual coding. An encoded video bitstream generally includes a series of values for syntax elements representative of coding decisions (e.g., coding modes) and partitioning of pictures into blocks. Thus, references to coding a picture or a block should generally be understood as coding values for syntax elements forming the picture or block.

HEVC defines various blocks, including coding units (CUs), prediction units (PUs), and transform units (TUs). According to HEVC, a video coder (such as video encoder 200) partitions a coding tree unit (CTU) into CUs according to a quadtree structure. That is, the video coder partitions CTUs and CUs into four equal, non-overlapping squares, and each node of the quadtree has either zero or four child nodes. Nodes without child nodes may be referred to as “leaf nodes,” and CUs of such leaf nodes may include one or more PUs and/or one or more TUs. The video coder may further partition PUs and TUs. For example, in HEVC, a residual quadtree (RQT) represents partitioning of TUs. In HEVC, PUs represent inter-prediction data, while TUs represent residual data. CUs that are intra-predicted include intra-prediction information, such as an intra-mode indication.

As another example, video encoder 200 and video decoder 300 may be configured to operate according to VVC. According to VVC, a video coder (such as video encoder 200) partitions a picture into a plurality of CTUs. Video encoder 200 may partition a CTU according to a tree structure, such as a quadtree-binary tree (QTBT) structure or Multi-Type Tree (MTT) structure. The QTBT structure removes the concepts of multiple partition types, such as the separation between CUs, PUs, and TUs of HEVC. A QTBT structure includes two levels: a first level partitioned according to quadtree partitioning, and a second level partitioned according to binary tree partitioning. A root node of the QTBT structure corresponds to a CTU. Leaf nodes of the binary trees correspond to CUs.

In an MTT partitioning structure, blocks may be partitioned using a quadtree (QT) partition, a binary tree (BT) partition, and one or more types of triple tree (TT) (also called ternary tree (TT)) partitions. A triple or ternary tree partition is a partition where a block is split into three sub-blocks. In some examples, a triple or ternary tree partition divides a block into three sub-blocks without dividing the original block through the center. The partitioning types in MTT (e.g., QT, BT, and TT), may be symmetrical or asymmetrical.

When operating according to the AV1 codec, video encoder 200 and video decoder 300 may be configured to code video data in blocks. In AV1, the largest coding block that can be processed is called a superblock. In AV1, a superblock can be either 128×128 luma samples or 64×64 luma samples. However, in successor video coding formats (e.g., AV2), a superblock may be defined by different (e.g., larger) luma sample sizes. In some examples, a superblock is the top level of a block quadtree. Video encoder 200 may further partition a superblock into smaller coding blocks. Video encoder 200 may partition a superblock and other coding blocks into smaller blocks using square or non-square partitioning. Non-square blocks may include N/2×N, N×N/2, N/4×N, and N×N/4 blocks. Video encoder 200 and video decoder 300 may perform separate prediction and transform processes on each of the coding blocks.

AV1 also defines a tile of video data. A tile is a rectangular array of superblocks that may be coded independently of other tiles. That is, video encoder 200 and video decoder 300 may encode and decode, respectively, coding blocks within a tile without using video data from other tiles. However, video encoder 200 and video decoder 300 may perform filtering across tile boundaries. Tiles may be uniform or non-uniform in size. Tile-based coding may enable parallel processing and/or multi-threading for encoder and decoder implementations.

In some examples, video encoder 200 and video decoder 300 may use a single QTBT or MTT structure to represent each of the luminance and chrominance components, while in other examples, video encoder 200 and video decoder 300 may use two or more QTBT or MTT structures, such as one QTBT/MTT structure for the luminance component and another QTBT/MTT structure for both chrominance components (or two QTBT/MTT structures for respective chrominance components).

Video encoder 200 and video decoder 300 may be configured to use quadtree partitioning, QTBT partitioning, MTT partitioning, superblock partitioning, or other partitioning structures.

In some examples, a CTU includes a coding tree block (CTB) of luma samples, two corresponding CTBs of chroma samples of a picture that has three sample arrays, or a CTB of samples of a monochrome picture or a picture that is coded using three separate color planes and syntax structures used to code the samples. A CTB may be an N×N block of samples for some value of N such that the division of a component into CTBs is a partitioning. A component may be an array or single sample from one of the three arrays (luma and two chroma) for a picture in 4:2:0, 4:2:2, or 4:4:4 color format, or an array or a single sample of the array for a picture in monochrome format. In some examples, a coding block is an M×N block of samples for some values of M and N such that a division of a CTB into coding blocks is a partitioning.

The blocks (e.g., CTUs or CUs) may be grouped in various ways in a picture. As one example, a brick may refer to a rectangular region of CTU rows within a particular tile in a picture. A tile may be a rectangular region of CTUs within a particular tile column and a particular tile row in a picture. A tile column refers to a rectangular region of CTUs having a height equal to the height of the picture and a width specified by syntax elements (e.g., such as in a picture parameter set). A tile row refers to a rectangular region of CTUs having a height specified by syntax elements (e.g., such as in a picture parameter set) and a width equal to the width of the picture.

In some examples, a tile may be partitioned into multiple bricks, each of which may include one or more CTU rows within the tile. A tile that is not partitioned into multiple bricks may also be referred to as a brick. However, a brick that is a true subset of a tile may not be referred to as a tile. The bricks in a picture may also be arranged in a slice. A slice may be an integer number of bricks of a picture that may be exclusively contained in a single network abstraction layer (NAL) unit. In some examples, a slice includes either a number of complete tiles or only a consecutive sequence of complete bricks of one tile.

This disclosure may use “N×N” and “N by N” interchangeably to refer to the sample dimensions of a block (such as a CU or other video block) in terms of vertical and horizontal dimensions, e.g., 16×16 samples or 16 by 16 samples. In general, a 16×16 CU will have 16 samples in a vertical direction (y=16) and 16 samples in a horizontal direction (x=16). Likewise, an N×N CU generally has N samples in a vertical direction and N samples in a horizontal direction, where N represents a nonnegative integer value. The samples in a CU may be arranged in rows and columns. Moreover, CUs need not necessarily have the same number of samples in the horizontal direction as in the vertical direction. For example, CUs may have N×M samples, where M is not necessarily equal to N.

Video encoder 200 encodes video data for CUs representing prediction and/or residual information, and other information. The prediction information indicates how the CU is to be predicted in order to form a prediction block for the CU. The residual information generally represents sample-by-sample differences between samples of the CU prior to encoding and the prediction block.

To predict a CU, video encoder 200 may generally form a prediction block for the CU through inter-prediction or intra-prediction. Inter-prediction generally refers to predicting the CU from data of a previously coded picture, whereas intra-prediction generally refers to predicting the CU from previously coded data of the same picture. To perform inter-prediction, video encoder 200 may generate the prediction block using one or more motion vectors. Video encoder 200 may generally perform a motion search to identify a reference block that closely matches the CU, e.g., in terms of differences between the CU and the reference block. Video encoder 200 may calculate a difference metric using a sum of absolute difference (SAD), sum of squared differences (SSD), mean absolute difference (MAD), mean squared differences (MSD), or other such difference calculations to determine whether a reference block closely matches the current CU. In some examples, video encoder 200 may predict the current CU using uni-directional prediction or bi-directional prediction.

Some examples of VVC also provide an affine motion compensation mode, which may be considered an inter-prediction mode. In affine motion compensation mode, video encoder 200 may determine two or more motion vectors that represent non-translational motion, such as zoom in or out, rotation, perspective motion, or other irregular motion types.

To perform intra-prediction, video encoder 200 may select an intra-prediction mode to generate the prediction block. Some examples of VVC provide sixty-seven intra-prediction modes, including various directional modes, as well as planar mode and DC mode. In general, video encoder 200 selects an intra-prediction mode that describes neighboring samples to a current block (e.g., a block of a CU) from which to predict samples of the current block. Such samples may generally be above, above and to the left, or to the left of the current block in the same picture as the current block, assuming video encoder 200 codes CTUs and CUs in raster scan order (left to right, top to bottom).

Video encoder 200 encodes data representing the prediction mode for a current block. For example, for inter-prediction modes, video encoder 200 may encode data representing which of the various available inter-prediction modes is used, as well as motion information for the corresponding mode. For uni-directional or bi-directional inter-prediction, for example, video encoder 200 may encode motion vectors using advanced motion vector prediction (AMVP) or merge mode. Video encoder 200 may use similar modes to encode motion vectors for affine motion compensation mode.

AV1 includes two general techniques for encoding and decoding a coding block of video data. The two general techniques are intra prediction (e.g., intra frame prediction or spatial prediction) and inter prediction (e.g., inter frame prediction or temporal prediction). In the context of AV1, when predicting blocks of a current frame of video data using an intra prediction mode, video encoder 200 and video decoder 300 do not use video data from other frames of video data. For most intra prediction modes, video encoder 200 encodes blocks of a current frame based on the difference between sample values in the current block and predicted values generated from reference samples in the same frame. Video encoder 200 determines predicted values generated from the reference samples based on the intra prediction mode.

Following prediction, such as intra-prediction or inter-prediction of a block, video encoder 200 may calculate residual data for the block. The residual data, such as a residual block, represents sample by sample differences between the block and a prediction block for the block, formed using the corresponding prediction mode. Video encoder 200 may apply one or more transforms to the residual block, to produce transformed data in a transform domain instead of the sample domain. For example, video encoder 200 may apply a discrete cosine transform (DCT), an integer transform, a wavelet transform, or a conceptually similar transform to residual video data. Additionally, video encoder 200 may apply a secondary transform following the first transform, such as a mode-dependent non-separable secondary transform (MDNSST), a signal dependent transform, a Karhunen-Loeve transform (KLT), or the like. Video encoder 200 produces transform coefficients following application of the one or more transforms.

As noted above, following any transforms to produce transform coefficients, video encoder 200 may perform quantization of the transform coefficients. Quantization generally refers to a process in which transform coefficients are quantized to possibly reduce the amount of data used to represent the transform coefficients, providing further compression. By performing the quantization process, video encoder 200 may reduce the bit depth associated with some or all of the transform coefficients. For example, video encoder 200 may round an n-bit value down to an m-bit value during quantization, where n is greater than m. In some examples, to perform quantization, video encoder 200 may perform a bitwise right-shift of the value to be quantized.

Following quantization, video encoder 200 may scan the transform coefficients, producing a one-dimensional vector from the two-dimensional matrix including the quantized transform coefficients. The scan may be designed to place higher energy (and therefore lower frequency) transform coefficients at the front of the vector and to place lower energy (and therefore higher frequency) transform coefficients at the back of the vector. In some examples, video encoder 200 may utilize a predefined scan order to scan the quantized transform coefficients to produce a serialized vector, and then entropy encode the quantized transform coefficients of the vector. In other examples, video encoder 200 may perform an adaptive scan. After scanning the quantized transform coefficients to form the one-dimensional vector, video encoder 200 may entropy encode the one-dimensional vector, e.g., according to context-adaptive binary arithmetic coding (CABAC). Video encoder 200 may also entropy encode values for syntax elements describing metadata associated with the encoded video data for use by video decoder 300 in decoding the video data.

To perform CABAC, video encoder 200 may assign a context within a context model to a symbol to be transmitted. The context may relate to, for example, whether neighboring values of the symbol are zero-valued or not. The probability determination may be based on a context assigned to the symbol.

Video encoder 200 may further generate syntax data, such as block-based syntax data, picture-based syntax data, and sequence-based syntax data, to video decoder 300, e.g., in a picture header, a block header, a slice header, or other syntax data, such as a sequence parameter set (SPS), picture parameter set (PPS), or video parameter set (VPS). Video decoder 300 may likewise decode such syntax data to determine how to decode corresponding video data.

In this manner, video encoder 200 may generate a bitstream including encoded video data, e.g., syntax elements describing partitioning of a picture into blocks (e.g., CUs) and prediction and/or residual information for the blocks. Ultimately, video decoder 300 may receive the bitstream and decode the encoded video data.

In general, video decoder 300 performs a reciprocal process to that performed by video encoder 200 to decode the encoded video data of the bitstream. For example, video decoder 300 may decode values for syntax elements of the bitstream using CABAC in a manner substantially similar to, albeit reciprocal to, the CABAC encoding process of video encoder 200. The syntax elements may define partitioning information for partitioning of a picture into CTUs, and partitioning of each CTU according to a corresponding partition structure, such as a QTBT structure, to define CUs of the CTU. The syntax elements may further define prediction and residual information for blocks (e.g., CUs) of video data.

The residual information may be represented by, for example, quantized transform coefficients. Video decoder 300 may inverse quantize and inverse transform the quantized transform coefficients of a block to reproduce a residual block for the block. Video decoder 300 uses a signaled prediction mode (intra- or inter-prediction) and related prediction information (e.g., motion information for inter-prediction) to form a prediction block for the block. Video decoder 300 may then combine the prediction block and the residual block (on a sample-by-sample basis) to reproduce the original block. Video decoder 300 may perform additional processing, such as performing a deblocking process to reduce visual artifacts along boundaries of the block.

Any of the video encoding or video decoding processes described above may be performed using a neural network (NN). Additionally or alternatively, a neural network may be trained to efficiently compress video data without necessarily separately performing prediction and residual coding. Studies have shown that embedding neural networks into the hybrid video coding framework of video encoder 200 and video decoder 300 can improve compression efficiency. Neural networks may be used for intra prediction and inter prediction to improve the prediction efficiency. NN-based in-loop filtering and/or post-filtering have also performed well in heuristic testing.

For example, video encoder 200 and video decoder 300 may use one or more NN-based filters for existing filters, such as deblocking filters, sample adaptive offset (SAO), and/or adaptive loop filtering (ALF). NN-based filters can also be applied exclusively, where NN-based filters are designed to replace all of the existing filters. Additionally or alternatively, NN-based filters may be designed to supplement, enhance, or replace any or all of the other filters.

In some examples, an NN-based filter may be a convolutional neural network (CNN)-based filter with multiple layers. An NN-based filtering process may take reconstructed samples as inputs, and may add the intermediate outputs back to the inputs to refine the input samples. The NN-based filter may use all color components (e.g., Y, U, and V, or Y, Cb, and Cr) as inputs to exploit cross-component correlations. Different color components may share the same filters (including network structure and model parameters) or each component may have its own specific filters.

The filtering process can also be generalized as follows:

$${R}^{′} ( i , j ) = R ( i , j ) + NN\_filter \_residual \_ouput ( R )$$

Here, R (i, j) represents a reconstructed sample at position (i, j) in the picture, R′ (i, j) represents the filtered version of the reconstructed sample, and
NN_filter_residual_output (R) represents the intermediate samples discussed above that are calculated by the NN filter. The model structure and model parameters of NN-based filter(s) can be pre-defined and be stored at video encoder 200 and video decoder 300. The filters can also be signalled in the bitstream.

In some examples, an NN-based filter may include a series of feature extraction layers, followed by an output convolution. The feature extraction layers may include a 3×3 convolution (conv) layer followed by a parametric rectified linear unit (PReLU) layer. The convolutional layer applies a convolution operation to the input data, which involves a filter or kernel processing the input data (e.g., the reconstruction samples) in a sliding window fashion and computing dot products at each position. The convolution operation essentially captures local patterns within the input data. For example, in the context of image processing, these patterns could be edges, textures, or other visual features. The filter or kernel is a small matrix of weights that gets updated during the training process. By sliding this filter across the input data (or feature map from a previous layer) and computing the dot product at each position, the convolutional layer creates a feature map that encodes spatial hierarchies and patterns detected in the input. The output of a convolutional layer is a set of feature maps, each corresponding to one filter, capturing different aspects of the input data. This layer helps the neural network to learn increasingly complex and abstract features as the data passes through deeper layers of the network.

The PRELU layer is an activation function used in neural networks, and is a variant of the ReLU (Rectified Linear Unit) activation function. As described above, the convolution layer outputs feature maps, each corresponding to one filter, representing detected features in the input. Following the convolution layer, the PRELU layer applies the PRELU activation function to each element of the feature maps produced by the convolution layer. For positive values, the PRELU layer acts like a standard ReLU, passing the value through. For negative values, instead of setting them to zero (e.g., as ReLU does), the PRELU layer allows a small, linear, negative output. This keeps neurons of the NN active and maintains the gradient flow, which can be beneficial for learning in deep networks.

When NN-based filtering is applied in video coding, the whole video signal (pixel data) may be split into multiple processing units (e.g., 2D blocks), and each processing unit can be processed separately or be combined with other information associated with this block of pixels. For example, a processing unit may be a frame, a slice/tile, a CTU, or any pre-defined or signaled shapes and sizes. Typically, NN-based filtering is performed on reconstructed blocks of video data. Here, reconstructed blocks and samples may refer to both decoded blocks produced by video decoder 300, as well blocks reconstructed in a reconstruction loop of video encoder 200.

To further improve the performance of NN-based filtering, different types of input data can be processed jointly to produce the filtered output. Input data may include, but is not limited to, reconstruction pixels/samples, prediction pixels/samples, pixels/samples after the loop filter(s), partitioning structure information, deblocking parameters (e.g., boundary strength (BS)), quantization parameter (QP) values, slice or picture types, or a filters applicability or coding modes map. Input data can be provided at different granularities. Luma reconstruction and prediction samples may be provided at the original resolution, whereas chroma samples may be provided at lower resolution, e.g. for 4:2:0 representation, or can be up-sampled to the Luma resolution to achieve per-pixel representation. Similarly, QP, BS, partitioning, or coding mode information can be provided at lower resolution, including cases with a single value per frame, slice or processing block (e.g. QP). In other examples, QP, BS, partitioning, or coding mode information can be expanded (e.g., replicated) to achieve per-pixel/sample representation.

To further improve the performance of NN-based filtering, multi-mode solutions can be used. For example, for each processing unit, video encoder 200 may select a mode from a set of modes based on rate-distortion optimization and signal the selected mode in the bit-stream. The different modes may include different NN models, different values that may be used as the input information of the NN models, etc. In one example, video encoder 200 and video decoder 300 may use an NN-based filtering solution with multiple modes based on a single NN model by using different QP values as input to the NN model for different modes.

This disclosure may generally refer to “signaling” certain information, such as syntax elements. The term “signaling” may generally refer to the communication of values for syntax elements and/or other data used to decode encoded video data. That is, video encoder 200 may signal values for syntax elements in the bitstream. In general, signaling refers to generating a value in the bitstream. As noted above, source device 102 may transport the bitstream to destination device 116 substantially in real time, or not in real time, such as might occur when storing syntax elements to storage device 112 for later retrieval by destination device 116.

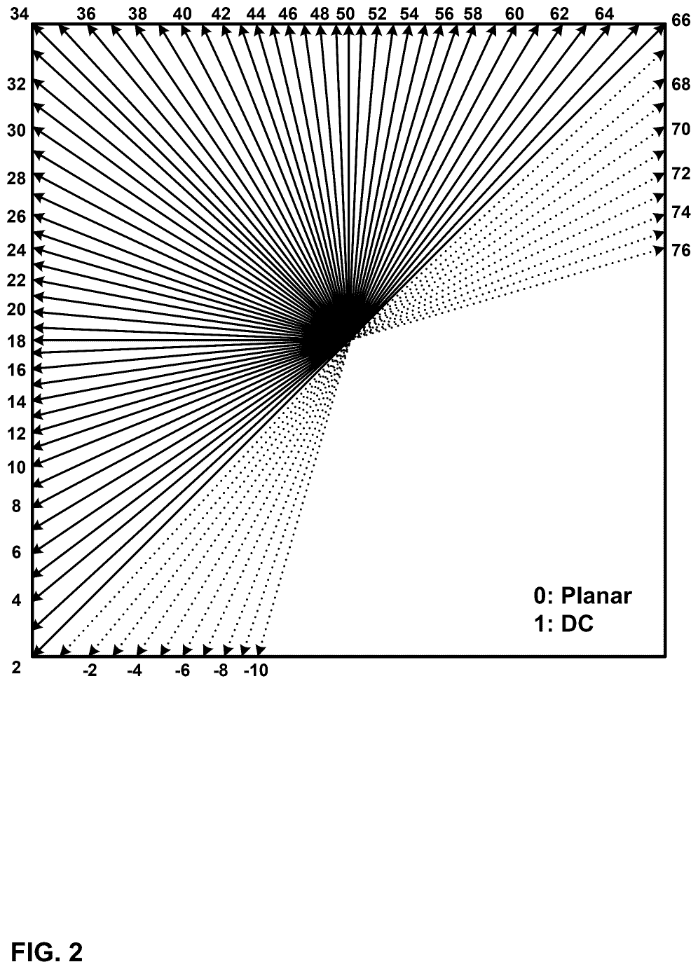

FIG. 2 is a conceptual diagram illustrating various example intra prediction modes. To capture the arbitrary edge directions presented in natural video, the number of directional intra modes may be 65. Example directional modes are depicted in FIG. 2, and planar and DC modes may also be used. These dense directional intra prediction modes may apply to all block sizes and for both luma and chroma intra predictions.

Characteristics of an intra block and its corresponding residual may be strongly correlated with the intra mode being used to predict the block. Consequently, multiple tools take advantage of this matter by making their behavior dependent on the intra mode currently being used:
Transforms: Multiple Transform Selection (MTS) uses the intra mode (in addition to other information like block shape and mtsIdx) to select the pair of separable transforms.
Transforms: Low-Frequency Non-Separable Transform (LFNST) and Non-Separable Primary Transform (NSPT) use the intra mode (in addition to other information like block shape and lfnstIdx) to select the Transform Kernel. Decoder-Side Intra Mode Derivation (DIMD) is a tool which may be used to derive the intra mode and prediction of the current block by analyzing the decoded content around the current block. The content may be analyzed by constructing a histogram of gradients using the decoded content and selecting the most appropriate mode (or multiple modes) from this histogram. The final prediction may be derived from blending operations.

Another use of DIMD is to derive an equivalent intra mode of the current block, for which the prediction has already been computed through another intra tool. In this case, the predicted block (as opposed to the decoded neighborhood) may be used to derive the histogram of gradients. Multiple intra tools take advantage of this method in order to derive an equivalent intra mode, making their tool compatible with mode-dependent tools described in the section above. Examples for those tools are Intra Template Matching Prediction (ITMP), Matrix-based Intra Prediction (MIP) and Extrapolation filter-based Intra Prediction (EIP). DIMD is also applied to Inter-coded blocks to derive an equivalent mode for Inter-Transforms (e.g. Inter-NSPT).

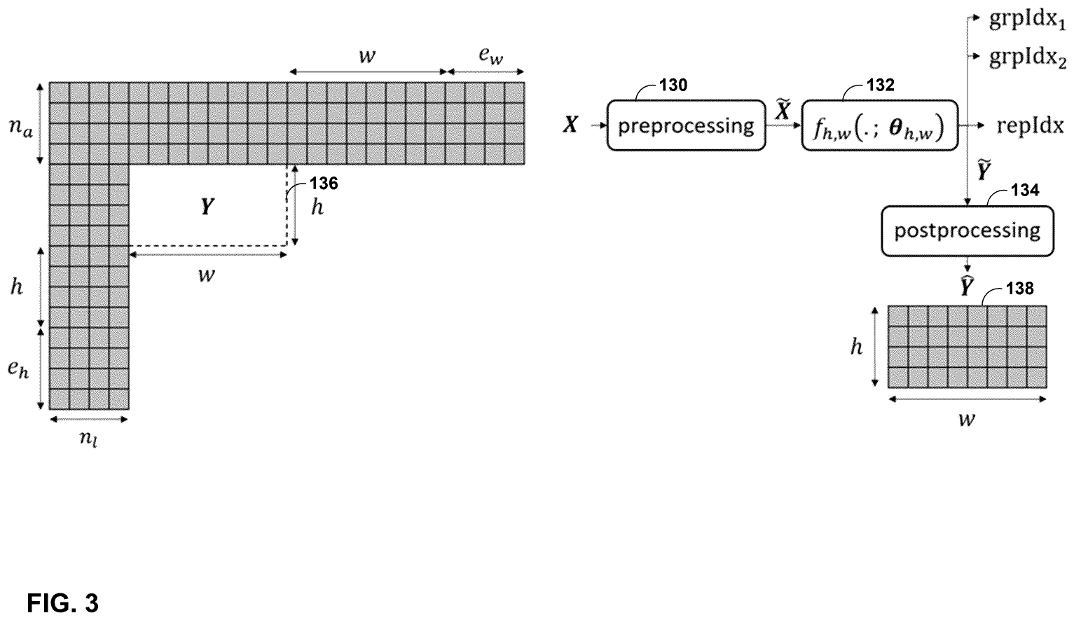

FIG. 3 is a conceptual diagram illustrating prediction of a current block 136 from a context of neighboring reference samples. A neural network (NN)-based intra prediction tool is described in jvet-experts.org/doc_end_user/current_document.php?id=14053 and in jvet-experts.org/doc_end_user/current_document.php?id=13912. FIG. 3 depicts an example NN-based intra prediction tool pipeline. In this example, the NN-based intra prediction tool pipeline includes preprocessing unit 130, NN model 132, and postprocessing unit 134. In general, the NN-based intra prediction tool pipeline generates prediction block 138 for current block 136, as discussed in greater detail below.

Using preprocessed (e.g., mean-removed & vectorized), decoded pixels \tilde{X} a model f_{h,w}(.; θ_{h,w}) (NN model 132) of a NN-architecture (here: fully connected, varying number of layers depending on block shape), derives a prediction Ý (prediction block 138), an equivalent intra mode repIdx and grpIdx_i to be used to select the Transform Set.

In the described NN-tool, 7 dedicated models (for NN model 132) are used based on the block shape: 4×4, 4×8, 4×16, 4×32, 8×8, 8×16, 16×16. However, additional and larger blocks are supported utilizing transposition and upsampling, summarized in the following table:

| (h, w) height | | | | |
|---|---|---|---|---|
| and width of | | | | Neural |
| block to be | | | | network used |
| predicted | γ | δ | transposition | for prediction |
| (4, 4) | 1 | 1 | no | f_{4, 4}(., θ_{4, 4}) |
| (4, 8) | 1 | 1 | no | f_{4, 8}(., θ_{4, 8}) |
| (8, 4) | 1 | 1 | yes | f_{8, 4}(., θ_{4, 8}) |
| (4, 16) | 1 | 1 | no | f_{4, 16}(., θ_{4, 16}) |
| (16, 4) | 1 | 1 | yes | f_{4, 16}(., θ_{4, 16}) |
| (4, 32) | 1 | 1 | no | f_{4, 32}(., θ_{4, 32}) |
| (32, 4) | 1 | 1 | yes | f_{4, 32}(., θ_{4, 32}) |
| (8, 8) | 1 | 1 | no | f_{8, 8}(., θ_{8, 8}) |
| (8, 16) | 1 | 1 | no | f_{8, 16}(., θ_{8, 16}) |
| (16, 8) | 1 | 1 | yes | f_{8, 16}(., θ_{8, 16}) |
| (8, 32) | 2 | 1 | no | f_{8, 16}(., θ_{8, 16}) |
| (32, 8) | 1 | 2 | yes | f_{8, 16}(., θ_{8, 16}) |
| (16, 16) | 1 | 1 | no | f_{16, 16}(., θ_{16, 16}) |
| (16, 32) | 2 | 1 | no | f_{16, 16}(., θ_{16, 16}) |
| (32, 16) | 1 | 2 | no | f_{16, 16}(., θ_{16, 16}) |
| (32, 32) | 2 | 2 | no | f_{16, 16}(., θ_{16, 16}) |
| (64, 64) | 4 | 4 | no | f_{16, 16}(., θ_{16, 16}) |

Table: decision of transposing the context of the current w×h block to be predicted and the prediction of this block, the value of γ, and the value of δ, and the neural network belonging to the neural network-based intra prediction mode used for prediction for
each (h, w) ∈ T

This disclosure recognizes that, concerning NN-based Intra Prediction, deriving the equivalent intra mode (“repIdx”) through a NN-based Inference is computationally complex and less efficient (in terms of coding gain/runtime ratio) than using DIMD.

This disclosure describes techniques for using DIMD to derive the equivalent intra mode of an NN-based derived prediction.

In some examples, video encoder 200 and video decoder 300 may use DIMD for all block shapes supported by an NN-based derived prediction, on the prediction to derive an equivalent intra mode.

In some examples, video encoder 200 and video decoder 300 use DIMD on the prediction computed by an NN-based tool prior to upsampling. For example, a 64×64 block is supposed to be predicted. A 16×16 model first computes a 16×16 block. DIMD is applied to this 16×16 block to derive an equivalent intra mode. Finally, the 16×16 prediction is upsampled to 64×64.

In general, both mode derivation methods-DIMD and NN-based—may be supported simultaneously, e.g., by video encoder 200 and video decoder 300. Video encoder 200 and video decoder 300 may select between DIMD and NN-based according to various criteria, alone or in combination.

For example, DIMD may be used for all predictions that do not require upsampling. NN-based mode derivation may be used for blocks that do require upsampling, e.g., a block predicted using a 16×16 model and further upsampled to a 64×64 block.

As another example, DIMD may be used for small block shapes, e.g., up to 8×8. NN-based derivation may be used for all block shapes bigger 8×8.

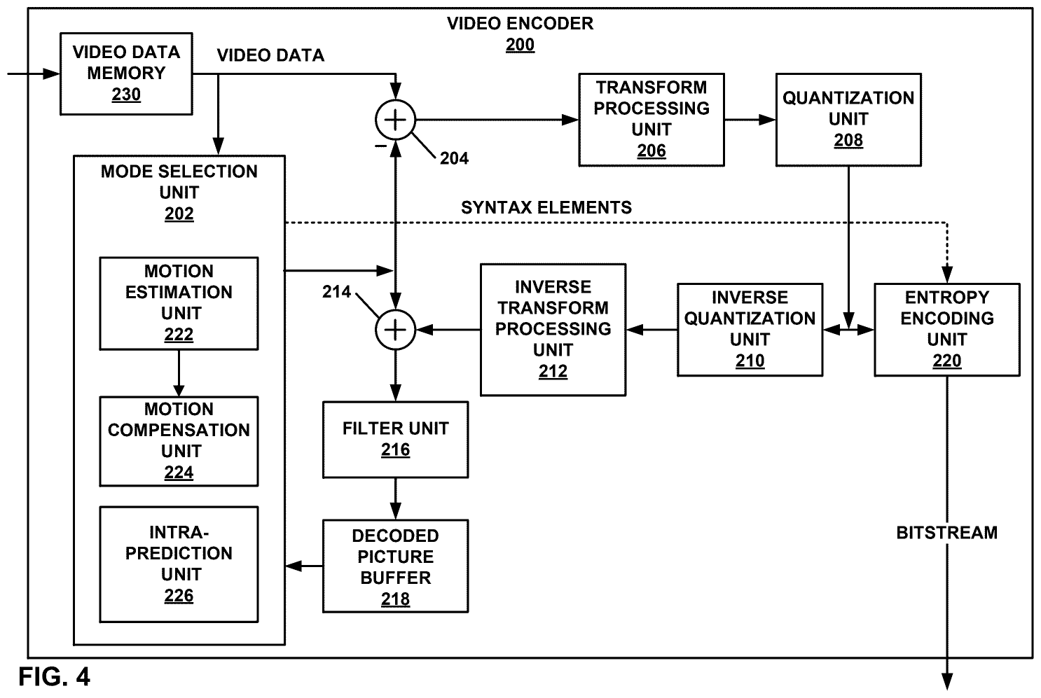

FIG. 4 is a block diagram illustrating an example video encoder 200 that may perform the techniques of this disclosure. FIG. 4 is provided for purposes of explanation and should not be considered limiting of the techniques as broadly exemplified and described in this disclosure. For purposes of explanation, this disclosure describes video encoder 200 according to the techniques of VVC (ITU-T H.266) and HEVC (ITU-T H.265). However, the techniques of this disclosure may be performed by video encoding devices that are configured to other video coding standards and video coding formats, such as AV1 and successors to the AV1 video coding format.

In the example of FIG. 4, video encoder 200 includes video data memory 230, mode selection unit 202, residual generation unit 204, transform processing unit 206, quantization unit 208, inverse quantization unit 210, inverse transform processing unit 212, reconstruction unit 214, filter unit 216, decoded picture buffer (DPB) 218, and entropy encoding unit 220. Any or all of video data memory 230, mode selection unit 202, residual generation unit 204, transform processing unit 206, quantization unit 208, inverse quantization unit 210, inverse transform processing unit 212, reconstruction unit 214, filter unit 216, DPB 218, and entropy encoding unit 220 may be implemented in one or more processors or in processing circuitry. For instance, the units of video encoder 200 may be implemented as one or more circuits or logic elements as part of hardware circuitry, or as part of a processor, ASIC, or FPGA. Moreover, video encoder 200 may include additional or alternative processors or processing circuitry to perform these and other functions.

Video data memory 230 is an example of a memory system that may store video data to be encoded by the components of video encoder 200. Video encoder 200 may receive the video data stored in video data memory 230 from, for example, video source 104 (FIG. 1). DPB 218 is an example of a memory system that may act as a reference picture memory that stores reference video data for use in prediction of subsequent video data by video encoder 200. Video data memory 230 and DPB 218 may each be formed by any of a variety of one or more memory devices or memory units, such as dynamic random access memory (DRAM), including synchronous DRAM (SDRAM), magnetoresistive RAM (MRAM), resistive RAM (RRAM), or other types of memory devices. Video data memory 230 and DPB 218 may be provided by the same memory device or separate memory devices. In various examples, video data memory 230 may be on-chip with other components of video encoder 200, as illustrated, or off-chip relative to those components.

In this disclosure, reference to video data memory 230 should not be interpreted as being limited to memory internal to video encoder 200, unless specifically described as such, or memory external to video encoder 200, unless specifically described as such. Rather, reference to video data memory 230 should be understood as reference memory that stores video data that video encoder 200 receives for encoding (e.g., video data for a current block that is to be encoded). Memory 106 of FIG. 1 may also provide temporary storage of outputs from the various units of video encoder 200.

The various units of FIG. 4 are illustrated to assist with understanding the operations performed by video encoder 200. The units may be implemented as fixed-function circuits, programmable circuits, or a combination thereof. Fixed-function circuits refer to circuits that provide particular functionality, and are preset on the operations that can be performed. Programmable circuits refer to circuits that can be programmed to perform various tasks, and provide flexible functionality in the operations that can be performed. For instance, programmable circuits may execute software or firmware that cause the programmable circuits to operate in the manner defined by instructions of the software or firmware. Fixed-function circuits may execute software instructions (e.g., to receive parameters or output parameters), but the types of operations that the fixed-function circuits perform are generally immutable. In some examples, one or more of the units may be distinct circuit blocks (fixed-function or programmable), and in some examples, one or more of the units may be integrated circuits.

Video encoder 200 may include arithmetic logic units (ALUs), elementary function units (EFUs), digital circuits, analog circuits, and/or programmable cores, formed from programmable circuits. In examples where the operations of video encoder 200 are performed using software executed by the programmable circuits, memory 106 (FIG. 1) may store the instructions (e.g., object code) of the software that video encoder 200 receives and executes, or another memory within video encoder 200 (not shown) may store such instructions.

Video data memory 230 is configured to store received video data. Video encoder 200 may retrieve a picture of the video data from video data memory 230 and provide the video data to residual generation unit 204 and mode selection unit 202. Video data in video data memory 230 may be raw video data that is to be encoded.

Mode selection unit 202 includes a motion estimation unit 222, a motion compensation unit 224, and an intra-prediction unit 226. Mode selection unit 202 may include additional functional units to perform video prediction in accordance with other prediction modes. As examples, mode selection unit 202 may include a palette unit, an intra-block copy unit (which may be part of motion estimation unit 222 and/or motion compensation unit 224), an affine unit, a linear model (LM) unit, or the like.

Mode selection unit 202 generally coordinates multiple encoding passes to test combinations of encoding parameters and resulting rate-distortion values for such combinations. The encoding parameters may include partitioning of CTUs into CUs, prediction modes for the CUS, transform types for residual data of the CUS, quantization parameters for residual data of the CUs, and so on. Mode selection unit 202 may ultimately select the combination of encoding parameters having rate-distortion values that are better than the other tested combinations.

Video encoder 200 may partition a picture retrieved from video data memory 230 into a series of CTUs, and encapsulate one or more CTUs within a slice. Mode selection unit 202 may partition a CTU of the picture in accordance with a tree structure, such as the MTT structure, QTBT structure, superblock structure, or the quad-tree structure described above. As described above, video encoder 200 may form one or more CUs from partitioning a CTU according to the tree structure. Such a CU may also be referred to generally as a “video block” or “block.”

In general, mode selection unit 202 also controls the components thereof (e.g., motion estimation unit 222, motion compensation unit 224, and intra-prediction unit 226) to generate a prediction block for a current block (e.g., a current CU, or in HEVC, the overlapping portion of a PU and a TU). For inter-prediction of a current block, motion estimation unit 222 may perform a motion search to identify one or more closely matching reference blocks in one or more reference pictures (e.g., one or more previously coded pictures stored in DPB 218). In particular, motion estimation unit 222 may calculate a value representative of how similar a potential reference block is to the current block, e.g., according to sum of absolute difference (SAD), sum of squared differences (SSD), mean absolute difference (MAD), mean squared differences (MSD), or the like. Motion estimation unit 222 may generally perform these calculations using sample-by-sample differences between the current block and the reference block being considered. Motion estimation unit 222 may identify a reference block having a lowest value resulting from these calculations, indicating a reference block that most closely matches the current block.

Motion estimation unit 222 may form one or more motion vectors (MVs) that define the positions of the reference blocks in the reference pictures relative to the position of the current block in a current picture. Motion estimation unit 222 may then provide the motion vectors to motion compensation unit 224. For example, for uni-directional inter-prediction, motion estimation unit 222 may provide a single motion vector, whereas for bi-directional inter-prediction, motion estimation unit 222 may provide two motion vectors. Motion compensation unit 224 may then generate a prediction block using the motion vectors. For example, motion compensation unit 224 may retrieve data of the reference block using the motion vector. As another example, if the motion vector has fractional sample precision, motion compensation unit 224 may interpolate values for the prediction block according to one or more interpolation filters. Moreover, for bi-directional inter-prediction, motion compensation unit 224 may retrieve data for two reference blocks identified by respective motion vectors and combine the retrieved data, e.g., through sample-by-sample averaging or weighted averaging.

When operating according to the AV1 video coding format, motion estimation unit 222 and motion compensation unit 224 may be configured to encode coding blocks of video data (e.g., both luma and chroma coding blocks) using translational motion compensation, affine motion compensation, overlapped block motion compensation (OBMC), and/or compound inter-intra prediction.

As another example, for intra-prediction, or intra-prediction coding, intra-prediction unit 226 may generate the prediction block from samples neighboring the current block. For example, for directional modes, intra-prediction unit 226 may generally mathematically combine values of neighboring samples and populate these calculated values in the defined direction across the current block to produce the prediction block. As another example, for DC mode, intra-prediction unit 226 may calculate an average of the neighboring samples to the current block and generate the prediction block to include this resulting average for each sample of the prediction block.

When operating according to the AV1 video coding format, intra-prediction unit 226 may be configured to encode coding blocks of video data (e.g., both luma and chroma coding blocks) using directional intra prediction, non-directional intra prediction, recursive filter intra prediction, chroma-from—luma (CFL) prediction, intra block copy (IBC), and/or color palette mode. Mode selection unit 202 may include additional functional units to perform video prediction in accordance with other prediction modes.

Mode selection unit 202 provides the prediction block to residual generation unit 204. Residual generation unit 204 receives a raw, uncoded version of the current block from video data memory 230 and the prediction block from mode selection unit 202. Residual generation unit 204 calculates sample-by-sample differences between the current block and the prediction block. The resulting sample-by-sample differences define a residual block for the current block. In some examples, residual generation unit 204 may also determine differences between sample values in the residual block to generate a residual block using residual differential pulse code modulation (RDPCM). In some examples, residual generation unit 204 may be formed using one or more subtractor circuits that perform binary subtraction.

In examples where mode selection unit 202 partitions CUs into PUs, each PU may be associated with a luma prediction unit and corresponding chroma prediction units. Video encoder 200 and video decoder 300 may support PUs having various sizes. As indicated above, the size of a CU may refer to the size of the luma coding block of the CU and the size of a PU may refer to the size of a luma prediction unit of the PU. Assuming that the size of a particular CU is 2N×2N, video encoder 200 may support PU sizes of 2N×2N or N×N for intra prediction, and symmetric PU sizes of 2N×2N, 2N×N, N×2N, N×N, or similar for inter prediction. Video encoder 200 and video decoder 300 may also support asymmetric partitioning for PU sizes of 2N×nU, 2N×nD, nL×2N, and nR×2N for inter prediction.

In examples where mode selection unit 202 does not further partition a CU into PUs, each CU may be associated with a luma coding block and corresponding chroma coding blocks. As above, the size of a CU may refer to the size of the luma coding block of the CU. The video encoder 200 and video decoder 300 may support CU sizes of 2N×2N, 2N×N, or N×2N.

For other video coding techniques such as an intra-block copy mode coding, an affine-mode coding, and linear model (LM) mode coding, as some examples, mode selection unit 202, via respective units associated with the coding techniques, generates a prediction block for the current block being encoded. In some examples, such as palette mode coding, mode selection unit 202 may not generate a prediction block, and instead generate syntax elements that indicate the manner in which to reconstruct the block based on a selected palette. In such modes, mode selection unit 202 may provide these syntax elements to entropy encoding unit 220 to be encoded.

As described above, residual generation unit 204 receives the video data for the current block and the corresponding prediction block. Residual generation unit 204 then generates a residual block for the current block. To generate the residual block, residual generation unit 204 calculates sample-by-sample differences between the prediction block and the current block.

Transform processing unit 206 applies one or more transforms to the residual block to generate a block of transform coefficients (referred to herein as a “transform coefficient block”). Transform processing unit 206 may apply various transforms to a residual block to form the transform coefficient block. For example, transform processing unit 206 may apply a discrete cosine transform (DCT), a directional transform, a Karhunen-Loeve transform (KLT), or a conceptually similar transform to a residual block. In some examples, transform processing unit 206 may perform multiple transforms to a residual block, e.g., a primary transform and a secondary transform, such as a rotational transform. In some examples, transform processing unit 206 does not apply transforms to a residual block.

When operating according to AV1, transform processing unit 206 may apply one or more transforms to the residual block to generate a block of transform coefficients (referred to herein as a “transform coefficient block”). Transform processing unit 206 may apply various transforms to a residual block to form the transform coefficient block. For example, transform processing unit 206 may apply a horizontal/vertical transform combination that may include a discrete cosine transform (DCT), an asymmetric discrete sine transform (ADST), a flipped ADST (e.g., an ADST in reverse order), and an identity transform (IDTX). When using an identity transform, the transform is skipped in one of the vertical or horizontal directions. In some examples, transform processing may be skipped.

Quantization unit 208 may quantize the transform coefficients in a transform coefficient block, to produce a quantized transform coefficient block. Quantization unit 208 may quantize transform coefficients of a transform coefficient block according to a quantization parameter (QP) value associated with the current block. Video encoder 200 (e.g., via mode selection unit 202) may adjust the degree of quantization applied to the transform coefficient blocks associated with the current block by adjusting the QP value associated with the CU. Quantization may introduce loss of information, and thus, quantized transform coefficients may have lower precision than the original transform coefficients produced by transform processing unit 206.

Inverse quantization unit 210 and inverse transform processing unit 212 may apply inverse quantization and inverse transforms to a quantized transform coefficient block, respectively, to reconstruct a residual block from the transform coefficient block. Reconstruction unit 214 may produce a reconstructed block corresponding to the current block (albeit potentially with some degree of distortion) based on the reconstructed residual block and a prediction block generated by mode selection unit 202. For example, reconstruction unit 214 may add samples of the reconstructed residual block to corresponding samples from the prediction block generated by mode selection unit 202 to produce the reconstructed block.

Filter unit 216 may perform one or more filter operations on reconstructed blocks. For example, filter unit 216 may perform deblocking operations to reduce blockiness artifacts along edges of CUs. Operations of filter unit 216 may be skipped, in some examples.

When operating according to AV1, filter unit 216 may perform one or more filter operations on reconstructed blocks. For example, filter unit 216 may perform deblocking operations to reduce blockiness artifacts along edges of CUs. In other examples, filter unit 216 may apply a constrained directional enhancement filter (CDEF), which may be applied after deblocking, and may include the application of non-separable, non-linear, low-pass directional filters based on estimated edge directions. Filter unit 216 may also include a loop restoration filter, which is applied after CDEF, and may include a separable symmetric normalized Wiener filter or a dual self-guided filter.

Video encoder 200 stores reconstructed blocks in DPB 218. For instance, in examples where operations of filter unit 216 are not performed, reconstruction unit 214 may store reconstructed blocks to DPB 218. In examples where operations of filter unit 216 are performed, filter unit 216 may store the filtered reconstructed blocks to DPB 218. Motion estimation unit 222 and motion compensation unit 224 may retrieve a reference picture from DPB 218, formed from the reconstructed (and potentially filtered) blocks, to inter-predict blocks of subsequently encoded pictures. In addition, intra-prediction unit 226 may use reconstructed blocks in DPB 218 of a current picture to intra-predict other blocks in the current picture.

In general, entropy encoding unit 220 may entropy encode syntax elements received from other functional components of video encoder 200. For example, entropy encoding unit 220 may entropy encode quantized transform coefficient blocks from quantization unit 208. As another example, entropy encoding unit 220 may entropy encode prediction syntax elements (e.g., motion information for inter-prediction or intra-mode information for intra-prediction) from mode selection unit 202. Entropy encoding unit 220 may perform one or more entropy encoding operations on the syntax elements, which are another example of video data, to generate entropy-encoded data. For example, entropy encoding unit 220 may perform a context-adaptive variable length coding (CAVLC) operation, a CABAC operation, a variable-to-variable (V2V) length coding operation, a syntax-based context-adaptive binary arithmetic coding (SBAC) operation, a Probability Interval Partitioning Entropy (PIPE) coding operation, an Exponential-Golomb encoding operation, or another type of entropy encoding operation on the data. In some examples, entropy encoding unit 220 may operate in bypass mode where syntax elements are not entropy encoded.

Video encoder 200 may output a bitstream that includes the entropy encoded syntax elements needed to reconstruct blocks of a slice or picture. In particular, entropy encoding unit 220 may output the bitstream.

In accordance with AV1, entropy encoding unit 220 may be configured as a symbol-to-symbol adaptive multi-symbol arithmetic coder. A syntax element in AV1 includes an alphabet of N elements, and a context (e.g., probability model) includes a set of N probabilities. Entropy encoding unit 220 may store the probabilities as n-bit (e.g., 15-bit) cumulative distribution functions (CDFs). Entropy encoding unit 220 may perform recursive scaling, with an update factor based on the alphabet size, to update the contexts.

The operations described above are described with respect to a block. Such description should be understood as being operations for a luma coding block and/or chroma coding blocks. As described above, in some examples, the luma coding block and chroma coding blocks are luma and chroma components of a CU. In some examples, the luma coding block and the chroma coding blocks are luma and chroma components of a PU.

In some examples, operations performed with respect to a luma coding block need not be repeated for the chroma coding blocks. As one example, operations to identify a motion vector (MV) and reference picture for a luma coding block need not be repeated for identifying a MV and reference picture for the chroma blocks. Rather, the MV for the luma coding block may be scaled to determine the MV for the chroma blocks, and the reference picture may be the same. As another example, the intra-prediction process may be the same for the luma coding block and the chroma coding blocks.

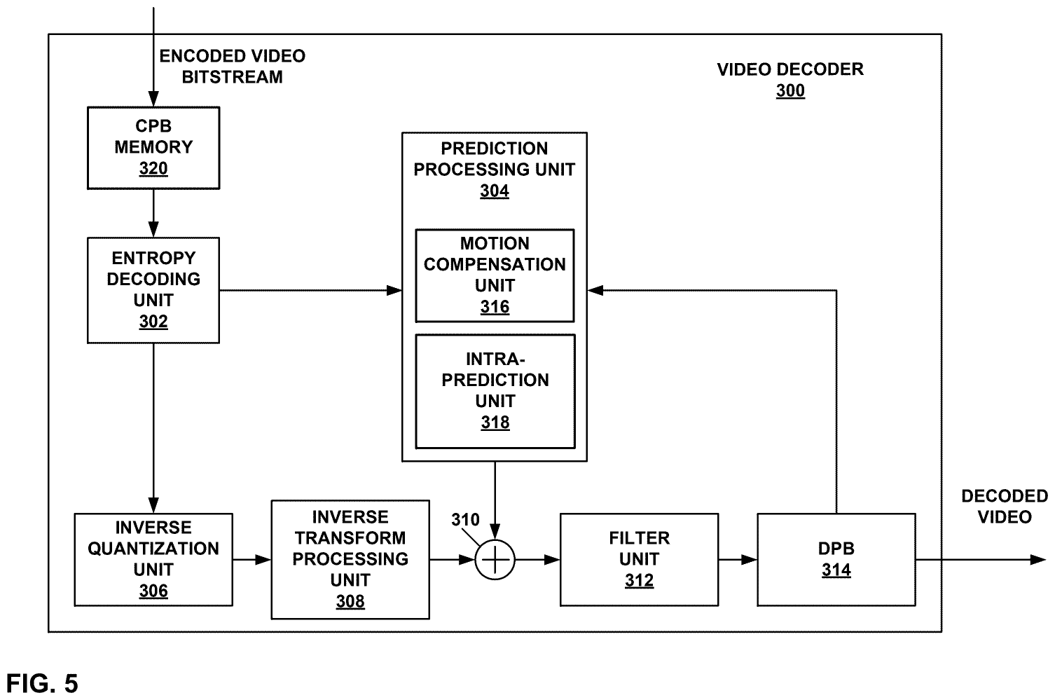

FIG. 5 is a block diagram illustrating an example video decoder 300 that may perform the techniques of this disclosure. FIG. 5 is provided for purposes of explanation and is not limiting on the techniques as broadly exemplified and described in this disclosure. For purposes of explanation, this disclosure describes video decoder 300 according to the techniques of VVC (ITU-T H.266) and HEVC (ITU-T H.265). However, the techniques of this disclosure may be performed by video coding devices that are configured to other video coding standards.

In the example of FIG. 5, video decoder 300 includes coded picture buffer (CPB) memory 320, entropy decoding unit 302, prediction processing unit 304, inverse quantization unit 306, inverse transform processing unit 308, reconstruction unit 310, filter unit 312, and decoded picture buffer (DPB) 314. Any or all of CPB memory 320, entropy decoding unit 302, prediction processing unit 304, inverse quantization unit 306, inverse transform processing unit 308, reconstruction unit 310, filter unit 312, and DPB 314 may be implemented in one or more processors or in processing circuitry. For instance, the units of video decoder 300 may be implemented as one or more circuits or logic elements as part of hardware circuitry, or as part of a processor, ASIC, or FPGA. Moreover, video decoder 300 may include additional or alternative processors or processing circuitry to perform these and other functions.

Prediction processing unit 304 includes motion compensation unit 316 and intra-prediction unit 318. Prediction processing unit 304 may include additional units to perform prediction in accordance with other prediction modes. As examples, prediction processing unit 304 may include a palette unit, an intra-block copy unit (which may form part of motion compensation unit 316), an affine unit, a linear model (LM) unit, or the like. In other examples, video decoder 300 may include more, fewer, or different functional components.

When operating according to AV1, motion compensation unit 316 may be configured to decode coding blocks of video data (e.g., both luma and chroma coding blocks) using translational motion compensation, affine motion compensation, OBMC, and/or compound inter-intra prediction, as described above. Intra-prediction unit 318 may be configured to decode coding blocks of video data (e.g., both luma and chroma coding blocks) using directional intra prediction, non-directional intra prediction, recursive filter intra prediction, CFL, intra block copy (IBC), and/or color palette mode, as described above.

CPB memory 320 is an example of a memory system that may store video data, such as an encoded video bitstream, to be decoded by the components of video decoder 300. The video data stored in CPB memory 320 may be obtained, for example, from computer-readable medium 110 (FIG. 1). CPB memory 320 may include a CPB that stores encoded video data (e.g., syntax elements) from an encoded video bitstream. Also, CPB memory 320 may store video data other than syntax elements of a coded picture, such as temporary data representing outputs from the various units of video decoder 300. DPB 314 is an example of a memory system that generally stores decoded pictures, which video decoder 300 may output and/or use as reference video data when decoding subsequent data or pictures of the encoded video bitstream. CPB memory 320 and DPB 314 may be formed by any of a variety of memory devices, such as dynamic random access memory (DRAM), including synchronous DRAM (SDRAM), magnetoresistive RAM (MRAM), resistive RAM (RRAM), or other types of memory devices. CPB memory 320 and DPB 314 may each be provided by the same memory device or separate memory devices or memory units. In various examples, CPB memory 320 may be on-chip with other components of video decoder 300, or off-chip relative to those components.

Additionally or alternatively, in some examples, video decoder 300 may retrieve coded video data from memory 120 (FIG. 1). That is, memory 120 may store data as discussed above with CPB memory 320. Likewise, memory 120 may store instructions to be executed by video decoder 300, when some or all of the functionality of video decoder 300 is implemented in software to be executed by processing circuitry of video decoder 300.

The various units shown in FIG. 5 are illustrated to assist with understanding the operations performed by video decoder 300. The units may be implemented as fixed-function circuits, programmable circuits, or a combination thereof. Similar to FIG. 4, fixed-function circuits refer to circuits that provide particular functionality, and are preset on the operations that can be performed. Programmable circuits refer to circuits that can be programmed to perform various tasks, and provide flexible functionality in the operations that can be performed. For instance, programmable circuits may execute software or firmware that cause the programmable circuits to operate in the manner defined by instructions of the software or firmware. Fixed-function circuits may execute software instructions (e.g., to receive parameters or output parameters), but the types of operations that the fixed-function circuits perform are generally immutable. In some examples, one or more of the units may be distinct circuit blocks (fixed-function or programmable), and in some examples, one or more of the units may be integrated circuits.

Video decoder 300 may include ALUs, EFUs, digital circuits, analog circuits, and/or programmable cores formed from programmable circuits. In examples where the operations of video decoder 300 are performed by software executing on the programmable circuits, on-chip or off-chip memory may store instructions (e.g., object code) of the software that video decoder 300 receives and executes.

Entropy decoding unit 302 may receive encoded video data from the CPB and entropy decode the video data to reproduce syntax elements. Prediction processing unit 304, inverse quantization unit 306, inverse transform processing unit 308, reconstruction unit 310, and filter unit 312 may generate decoded video data based on the syntax elements extracted from the bitstream.

In general, video decoder 300 reconstructs a picture on a block-by-block basis. Video decoder 300 may perform a reconstruction operation on each block individually (where the block currently being reconstructed, i.e., decoded, may be referred to as a “current block”).

Entropy decoding unit 302 may entropy decode syntax elements defining quantized transform coefficients of a quantized transform coefficient block, as well as transform information, such as a quantization parameter (QP) and/or transform mode indication(s). Inverse quantization unit 306 may use the QP associated with the quantized transform coefficient block to determine a degree of quantization and, likewise, a degree of inverse quantization for inverse quantization unit 306 to apply. Inverse quantization unit 306 may, for example, perform a bitwise left-shift operation to inverse quantize the quantized transform coefficients. Inverse quantization unit 306 may thereby form a transform coefficient block including transform coefficients.

After inverse quantization unit 306 forms the transform coefficient block, inverse transform processing unit 308 may apply one or more inverse transforms to the transform coefficient block to generate a residual block associated with the current block. For example, inverse transform processing unit 308 may apply an inverse DCT, an inverse integer transform, an inverse Karhunen-Loeve transform (KLT), an inverse rotational transform, an inverse directional transform, or another inverse transform to the transform coefficient block.

Furthermore, prediction processing unit 304 generates a prediction block according to prediction information syntax elements that were entropy decoded by entropy decoding unit 302. For example, if the prediction information syntax elements indicate that the current block is inter-predicted, motion compensation unit 316 may generate the prediction block. In this case, the prediction information syntax elements may indicate a reference picture in DPB 314 from which to retrieve a reference block, as well as a motion vector identifying a location of the reference block in the reference picture relative to the location of the current block in the current picture. Motion compensation unit 316 may generally perform the inter-prediction process in a manner that is substantially similar to that described with respect to motion compensation unit 224 (FIG. 4).

As another example, if the prediction information syntax elements indicate that the current block is intra-predicted, intra-prediction unit 318 may generate the prediction block according to an intra-prediction mode indicated by the prediction information syntax elements. Again, intra-prediction unit 318 may generally perform the intra-prediction process in a manner that is substantially similar to that described with respect to intra-prediction unit 226 (FIG. 4). Intra-prediction unit 318 may retrieve data of neighboring samples to the current block from DPB 314.

Reconstruction unit 310 may reconstruct the current block using the prediction block and the residual block. For example, reconstruction unit 310 may add samples of the residual block to corresponding samples of the prediction block to reconstruct the current block.

Filter unit 312 may perform one or more filter operations on reconstructed blocks. For example, filter unit 312 may perform deblocking operations to reduce blockiness artifacts along edges of the reconstructed blocks. Operations of filter unit 312 are not necessarily performed in all examples.

Video decoder 300 may store the reconstructed blocks in DPB 314. For instance, in examples where operations of filter unit 312 are not performed, reconstruction unit 310 may store reconstructed blocks to DPB 314. In examples where operations of filter unit 312 are performed, filter unit 312 may store the filtered reconstructed blocks to DPB 314. As discussed above, DPB 314 may provide reference information, such as samples of a current picture for intra-prediction and previously decoded pictures for subsequent motion compensation, to prediction processing unit 304. Moreover, video decoder 300 may output decoded pictures (e.g., decoded video) from DPB 314 for subsequent presentation on a display device, such as display device 118 of FIG. 1.

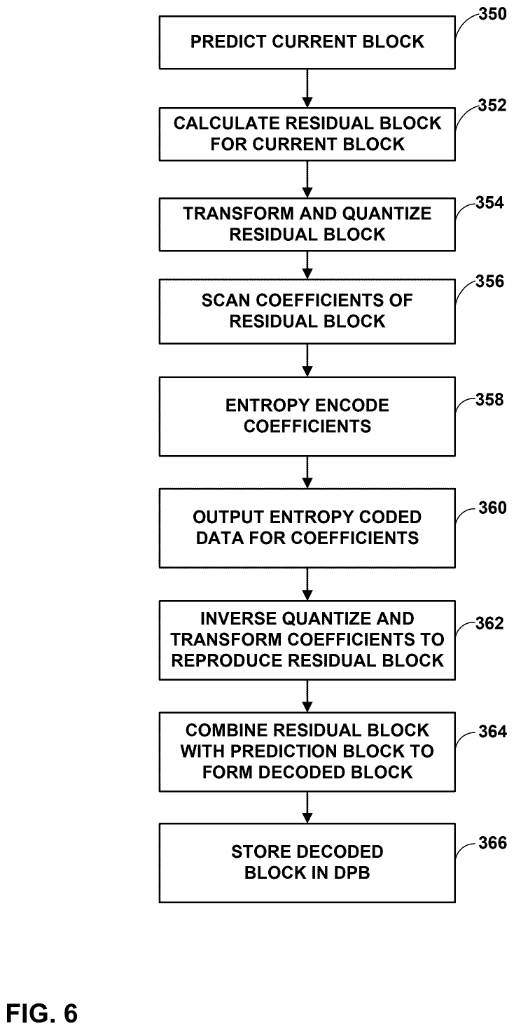

FIG. 6 is a flowchart illustrating an example method for encoding a current block in accordance with the techniques of this disclosure. The current block may include a current CU. Although described with respect to video encoder 200 (FIGS. 1 and 4), it should be understood that other devices may be configured to perform a method similar to that of FIG. 6.

In this example, video encoder 200 initially predicts the current block (350). For example, video encoder 200 may form a prediction block for the current block. Video encoder 200 may then calculate a residual block for the current block (352). To calculate the residual block, video encoder 200 may calculate a difference between the original, uncoded block and the prediction block for the current block. Video encoder 200 may then transform the residual block and quantize transform coefficients of the residual block (354). Next, video encoder 200 may scan the quantized transform coefficients of the residual block (356). During the scan, or following the scan, video encoder 200 may entropy encode the transform coefficients (358). For example, video encoder 200 may encode the transform coefficients using CAVLC or CABAC. Video encoder 200 may then output the entropy encoded data of the block (360).

Video encoder 200 may also decode the current block after encoding the current block, to use the decoded version of the current block as reference data for subsequently coded data (e.g., in inter- or intra-prediction modes). Thus, video encoder 200 may inverse quantize and inverse transform the coefficients to reproduce the residual block (362). Video encoder 200 may combine the residual block with the prediction block to form a decoded block (364). Video encoder 200 may then store the decoded block in DPB 218 (366).

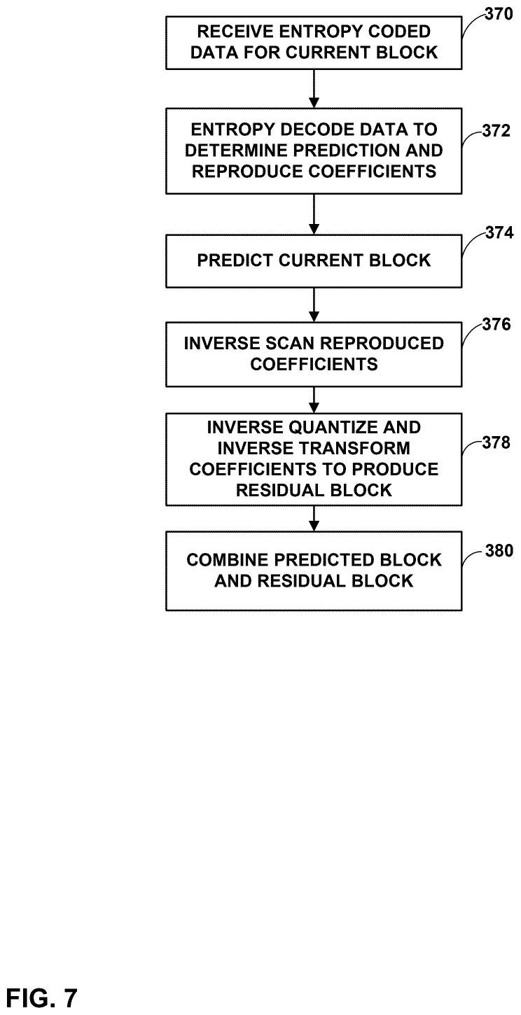

FIG. 7 is a flowchart illustrating an example method for decoding a current block of video data in accordance with the techniques of this disclosure. The current block may include a current CU. Although described with respect to video decoder 300 (FIGS. 1 and 5), it should be understood that other devices may be configured to perform a method similar to that of FIG. 7.

Video decoder 300 may receive entropy encoded data for the current block, such as entropy encoded prediction information and entropy encoded data for transform coefficients of a residual block corresponding to the current block (370). Video decoder 300 may entropy decode the entropy encoded data to determine prediction information for the current block and to reproduce transform coefficients of the residual block (372). Video decoder 300 may predict the current block (374), e.g., using an intra- or inter-prediction mode as indicated by the prediction information for the current block, to calculate a prediction block for the current block. Video decoder 300 may then inverse scan the reproduced transform coefficients (376), to create a block of quantized transform coefficients. Video decoder 300 may then inverse quantize the transform coefficients and apply an inverse transform to the transform coefficients to produce a residual block (378). Video decoder 300 may ultimately decode the current block by combining the prediction block and the residual block (380).

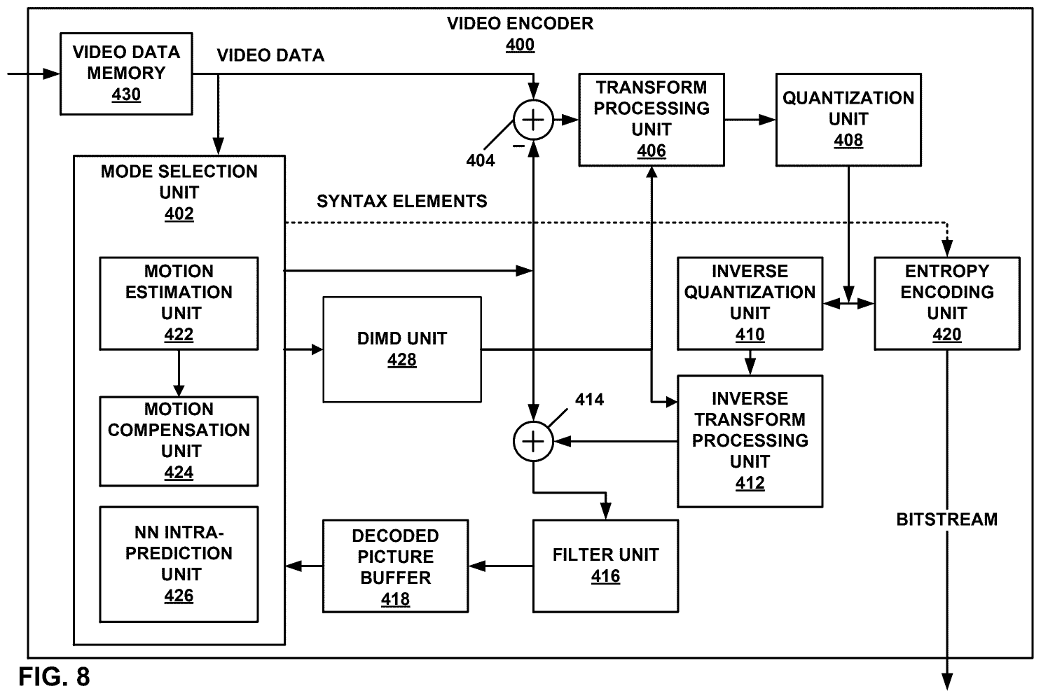

FIG. 8 is a block diagram illustrating example video encoder 400 per techniques of this disclosure. Video encoder 400 may be used in place of video encoder 200 in source device 102 of FIG. 1. FIG. 8 is provided for purposes of explanation and should not be considered limiting of the techniques as broadly exemplified and described in this disclosure. For purposes of explanation, this disclosure describes video encoder 400 according to the techniques of VVC (ITU-T H.266) and HEVC (ITU-T H.265). However, the techniques of this disclosure may be performed by video encoding devices that are configured to other video coding standards and video coding formats, such as AV1 and successors to the AV1 video coding format.

In the example of FIG. 8, video encoder 400 includes video data memory 430, mode selection unit 402, decoder-side intra mode derivation (DIMD) unit 428, residual generation unit 404, transform processing unit 406, quantization unit 408, inverse quantization unit 410, inverse transform processing unit 412, reconstruction unit 414, filter unit 416, decoded picture buffer (DPB) 418, and entropy encoding unit 420. Any or all of video data memory 430, mode selection unit 402, DIMD unit 428, residual generation unit 404, transform processing unit 406, quantization unit 408, inverse quantization unit 410, inverse transform processing unit 412, reconstruction unit 414, filter unit 416, DPB 418, and entropy encoding unit 420 may be implemented in one or more processors or in processing circuitry. For instance, the units of video encoder 400 may be implemented as one or more circuits or logic elements as part of hardware circuitry, or as part of a processor, ASIC, or FPGA. Moreover, video encoder 400 may include additional or alternative processors or processing circuitry to perform these and other functions.

Video data memory 430 is an example of a memory system that may store video data to be encoded by the components of video encoder 400. Video encoder 400 may receive the video data stored in video data memory 430 from, for example, video source 104 (FIG. 1). DPB 418 is an example of a memory system that may act as a reference picture memory that stores reference video data for use in prediction of subsequent video data by video encoder 400. Video data memory 430 and DPB 418 may each be formed by any of a variety of one or more memory devices or memory units, such as dynamic random access memory (DRAM), including synchronous DRAM (SDRAM), magnetoresistive RAM (MRAM), resistive RAM (RRAM), or other types of memory devices. Video data memory 430 and DPB 418 may be provided by the same memory device or separate memory devices. In various examples, video data memory 430 may be on-chip with other components of video encoder 400, as illustrated, or off-chip relative to those components.

In this disclosure, reference to video data memory 430 should not be interpreted as being limited to memory internal to video encoder 400, unless specifically described as such, or memory external to video encoder 400, unless specifically described as such. Rather, reference to video data memory 430 should be understood as reference memory that stores video data that video encoder 400 receives for encoding (e.g., video data for a current block that is to be encoded). Memory 106 of FIG. 1 may also provide temporary storage of outputs from the various units of video encoder 400.

The various units of FIG. 8 are illustrated to assist with understanding the operations performed by video encoder 400. The units may be implemented as fixed-function circuits, programmable circuits, or a combination thereof. Fixed-function circuits refer to circuits that provide particular functionality, and are preset on the operations that can be performed. Programmable circuits refer to circuits that can be programmed to perform various tasks, and provide flexible functionality in the operations that can be performed. For instance, programmable circuits may execute software or firmware that cause the programmable circuits to operate in the manner defined by instructions of the software or firmware. Fixed-function circuits may execute software instructions (e.g., to receive parameters or output parameters), but the types of operations that the fixed-function circuits perform are generally immutable. In some examples, one or more of the units may be distinct circuit blocks (fixed-function or programmable), and in some examples, one or more of the units may be integrated circuits.

Video encoder 400 may include arithmetic logic units (ALUs), elementary function units (EFUs), digital circuits, analog circuits, and/or programmable cores, formed from programmable circuits. In examples where the operations of video encoder 400 are performed using software executed by the programmable circuits, memory 106 (FIG. 1) may store the instructions (e.g., object code) of the software that video encoder 400 receives and executes, or another memory within video encoder 400 (not shown) may store such instructions.

Video data memory 430 is configured to store received video data. Video encoder 400 may retrieve a picture of the video data from video data memory 430 and provide the video data to residual generation unit 404 and mode selection unit 402. Video data in video data memory 430 may be raw video data that is to be encoded.

Mode selection unit 402 includes a motion estimation unit 422, a motion compensation unit 424, and a neural network (NN) intra-prediction unit 426. Mode selection unit 402 may include additional functional units to perform video prediction in accordance with other prediction modes. As examples, mode selection unit 402 may include a palette unit, an intra-block copy unit (which may be part of motion estimation unit 422 and/or motion compensation unit 424), an affine unit, a linear model (LM) unit, or the like.

Mode selection unit 402 generally coordinates multiple encoding passes to test combinations of encoding parameters and resulting rate-distortion values for such combinations. The encoding parameters may include partitioning of CTUs into CUs, prediction modes for the CUS, transform types for residual data of the CUS, quantization parameters for residual data of the CUs, and so on. Mode selection unit 402 may ultimately select the combination of encoding parameters having rate-distortion values that are better than the other tested combinations.

Video encoder 400 may partition a picture retrieved from video data memory 430 into a series of CTUs, and encapsulate one or more CTUs within a slice. Mode selection unit 402 may partition a CTU of the picture in accordance with a tree structure, such as the MTT structure, QTBT structure, superblock structure, or the quad-tree structure described above. As described above, video encoder 400 may form one or more CUs from partitioning a CTU according to the tree structure. Such a CU may also be referred to generally as a “video block” or “block.”

In general, mode selection unit 402 also controls the components thereof (e.g., motion estimation unit 422, motion compensation unit 424, and NN intra-prediction unit 426) to generate a prediction block for a current block (e.g., a current CU, or in HEVC, the overlapping portion of a PU and a TU). For inter-prediction of a current block, motion estimation unit 422 may perform a motion search to identify one or more closely matching reference blocks in one or more reference pictures (e.g., one or more previously coded pictures stored in DPB 418). In particular, motion estimation unit 422 may calculate a value representative of how similar a potential reference block is to the current block, e.g., according to sum of absolute difference (SAD), sum of squared differences (SSD), mean absolute difference (MAD), mean squared differences (MSD), or the like. Motion estimation unit 422 may generally perform these calculations using sample-by-sample differences between the current block and the reference block being considered. Motion estimation unit 422 may identify a reference block having a lowest value resulting from these calculations, indicating a reference block that most closely matches the current block.

Motion estimation unit 422 may form one or more motion vectors (MVs) that defines the positions of the reference blocks in the reference pictures relative to the position of the current block in a current picture. Motion estimation unit 422 may then provide the motion vectors to motion compensation unit 424. For example, for uni-directional inter-prediction, motion estimation unit 422 may provide a single motion vector, whereas for bi-directional inter-prediction, motion estimation unit 422 may provide two motion vectors. Motion compensation unit 424 may then generate a prediction block using the motion vectors. For example, motion compensation unit 424 may retrieve data of the reference block using the motion vector. As another example, if the motion vector has fractional sample precision, motion compensation unit 424 may interpolate values for the prediction block according to one or more interpolation filters. Moreover, for bi-directional inter-prediction, motion compensation unit 424 may retrieve data for two reference blocks identified by respective motion vectors and combine the retrieved data, e.g., through sample-by-sample averaging or weighted averaging.

When operating according to the AV1 video coding format, motion estimation unit 422 and motion compensation unit 424 may be configured to encode coding blocks of video data (e.g., both luma and chroma coding blocks) using translational motion compensation, affine motion compensation, overlapped block motion compensation (OBMC), and/or compound inter-intra prediction.

As another example, for intra-prediction, or intra-prediction coding, NN intra-prediction unit 426 may generate the prediction block from samples neighboring the current block. NN intra-prediction unit 426 may generally operate as discussed above with respect to FIG. 3.

DIMD unit 428 may determine an equivalent intra-prediction mode for a prediction block formed by NN intra-prediction unit 426. For example, DIMD unit 428 may determine which of the intra-prediction modes of FIG. 2 that, if used to form an intra-prediction block, would most closely match the prediction block generated by NN intra-prediction unit 426. To determine the equivalent intra-prediction mode, DIMD unit 428 may calculate gradients for samples of the prediction block formed by NN intra-prediction unit 426. DIMD unit 428 may then calculate a histogram from the gradients. For example, each gradient may correspond to an entry in the histogram, and each entry in the histogram may have a value corresponding to a number of times the corresponding gradient occurs in the prediction block formed by NN intra-prediction unit 426. DIMD unit 428 may then determine which of the gradients has the greatest value in the histogram and, thus, determine which of the intra-prediction modes (e.g., of FIG. 2) best corresponds to the histogram. DIMD unit 428 may then provide data representing the equivalent intra-prediction mode to transform processing unit 406 and to inverse transform processing unit 412.

In some examples, DIMD unit 428 may perform DIMD for NN intra-predicted blocks of all block shapes supported by NN-based derived prediction.

In some examples, DIMD unit 428 may perform DIMD on a NN-intra predicted block prior to upsampling. For example, if a current block is 64×64 and NN intra-prediction unit 426 generates a 16×16 intra-prediction block, DIMD unit 428 may perform DIMD on the 16×16 intra-prediction block, and then video encoder 400 may upsample the 16×16 intra-prediction block to a 64×64 block.

In some examples, video encoder 400 may support both DIMD and NN-based equivalent mode derivation. Video encoder 400 may select between DIMD unit 428 and a NN-based equivalent mode derivation unit based on various criteria, e.g., block size. For example, DIMD may be used for intra-prediction blocks not requiring upsampling, and NN-based equivalent mode derivation may be used for intra-prediction blocks requiring upsampling. As another example, DIMD may be used for relatively small intra-prediction blocks, e.g., up to 8×8, and NN-based equivalent mode derivations may be used for blocks having sizes larger than 8×8.

Mode selection unit 402 provides the prediction block to residual generation unit 404. Residual generation unit 404 receives a raw, uncoded version of the current block from video data memory 430 and the prediction block from mode selection unit 402. Residual generation unit 404 calculates sample-by-sample differences between the current block and the prediction block. The resulting sample-by-sample differences define a residual block for the current block. In some examples, residual generation unit 404 may also determine differences between sample values in the residual block to generate a residual block using residual differential pulse code modulation (RDPCM). In some examples, residual generation unit 404 may be formed using one or more subtractor circuits that perform binary subtraction.

In examples where mode selection unit 402 partitions CUs into PUs, each PU may be associated with a luma prediction unit and corresponding chroma prediction units. Video encoder 400 and video decoder 300 may support PUs having various sizes. As indicated above, the size of a CU may refer to the size of the luma coding block of the CU and the size of a PU may refer to the size of a luma prediction unit of the PU. Assuming that the size of a particular CU is 2N×2N, video encoder 400 may support PU sizes of 2N×2N or N×N for intra prediction, and symmetric PU sizes of 2N×2N, 2N×N, N×2N, N×N, or similar for inter prediction. Video encoder 400 and video decoder 300 may also support asymmetric partitioning for PU sizes of 2N×nU, 2N×nD, nL×2N, and nR×2N for inter prediction.

In examples where mode selection unit 402 does not further partition a CU into PUs, each CU may be associated with a luma coding block and corresponding chroma coding blocks. As above, the size of a CU may refer to the size of the luma coding block of the CU. The video encoder 400 and video decoder 300 may support CU sizes of 2N×2N, 2N×N, or N×2N.

For other video coding techniques such as an intra-block copy mode coding, an affine-mode coding, and linear model (LM) mode coding, as some examples, mode selection unit 402, via respective units associated with the coding techniques, generates a prediction block for the current block being encoded. In some examples, such as palette mode coding, mode selection unit 402 may not generate a prediction block, and instead generate syntax elements that indicate the manner in which to reconstruct the block based on a selected palette. In such modes, mode selection unit 402 may provide these syntax elements to entropy encoding unit 420 to be encoded.

As described above, residual generation unit 404 receives the video data for the current block and the corresponding prediction block. Residual generation unit 404 then generates a residual block for the current block. To generate the residual block, residual generation unit 404 calculates sample-by-sample differences between the prediction block and the current block.

Transform processing unit 406 applies one or more transforms to the residual block to generate a block of transform coefficients (referred to herein as a “transform coefficient block”). Transform processing unit 406 may apply various transforms to a residual block to form the transform coefficient block. For example, transform processing unit 406 may apply a discrete cosine transform (DCT), a directional transform, a Karhunen-Loeve transform (KLT), or a conceptually similar transform to a residual block. In some examples, transform processing unit 406 may perform multiple transforms to a residual block, e.g., a primary transform and a secondary transform, such as a rotational transform. In some examples, transform processing unit 406 does not apply transforms to a residual block.

Per techniques of this disclosure, transform processing unit 406 may select the one or more transforms to apply to a residual block corresponding to a NN intra-predicted block according to an equivalent intra-prediction mode for the NN intra-predicted block. For example, transform processing unit 406 may select a multi-transform selection (MTS) to which the equivalent intra-prediction mode is mapped and apply the MTS to the residual block. Alternatively, transform processing unit 406 may select a low-frequency non-separable transform (LFNST) and/or non-separable primary transform (NSPT) to which the equivalent intra-prediction mode is mapped and apply the LFNST and/or NSPT to the residual block.

When operating according to AV1, transform processing unit 406 may apply one or more transforms to the residual block to generate a block of transform coefficients (referred to herein as a “transform coefficient block”). Transform processing unit 406 may apply various transforms to a residual block to form the transform coefficient block. For example, transform processing unit 406 may apply a horizontal/vertical transform combination that may include a discrete cosine transform (DCT), an asymmetric discrete sine transform (ADST), a flipped ADST (e.g., an ADST in reverse order), and an identity transform (IDTX). When using an identity transform, the transform is skipped in one of the vertical or horizontal directions. In some examples, transform processing may be skipped.

Quantization unit 408 may quantize the transform coefficients in a transform coefficient block, to produce a quantized transform coefficient block. Quantization unit 408 may quantize transform coefficients of a transform coefficient block according to a quantization parameter (QP) value associated with the current block. Video encoder 400 (e.g., via mode selection unit 402) may adjust the degree of quantization applied to the transform coefficient blocks associated with the current block by adjusting the QP value associated with the CU. Quantization may introduce loss of information, and thus, quantized transform coefficients may have lower precision than the original transform coefficients produced by transform processing unit 406.

Inverse quantization unit 410 and inverse transform processing unit 412 may apply inverse quantization and inverse transforms to a quantized transform coefficient block, respectively, to reconstruct a residual block from the transform coefficient block. Per techniques of this disclosure, inverse transform processing unit 412 may select one or more inverse transforms to apply to a transform block corresponding to a NN intra-predicted block according to an equivalent intra-prediction mode for the NN intra-predicted block. For example, inverse transform processing unit 412 may select an inverse multi-transform selection (MTS) to which the equivalent intra-prediction mode is mapped and apply the inverse MTS to the transform block to reconstruct the residual block. Alternatively, inverse transform processing unit 412 may select an inverse low-frequency non-separable transform (LFNST) and/or an inverse non-separable primary transform (NSPT) to which the equivalent intra-prediction mode is mapped and apply the inverse LFNST and/or inverse NSPT to the transform block to reconstruct the residual block.

Reconstruction unit 414 may produce a reconstructed block corresponding to the current block (albeit potentially with some degree of distortion) based on the reconstructed residual block and a prediction block generated by mode selection unit 402. For example, reconstruction unit 414 may add samples of the reconstructed residual block to corresponding samples from the prediction block generated by mode selection unit 402 to produce the reconstructed block.

Filter unit 416 may perform one or more filter operations on reconstructed blocks. For example, filter unit 416 may perform deblocking operations to reduce blockiness artifacts along edges of CUs. Operations of filter unit 416 may be skipped, in some examples.

When operating according to AV1, filter unit 416 may perform one or more filter operations on reconstructed blocks. For example, filter unit 416 may perform deblocking operations to reduce blockiness artifacts along edges of CUs. In other examples, filter unit 416 may apply a constrained directional enhancement filter (CDEF), which may be applied after deblocking, and may include the application of non-separable, non-linear, low-pass directional filters based on estimated edge directions. Filter unit 416 may also include a loop restoration filter, which is applied after CDEF, and may include a separable symmetric normalized Wiener filter or a dual self-guided filter.

Video encoder 400 stores reconstructed blocks in DPB 418. For instance, in examples where operations of filter unit 416 are not performed, reconstruction unit 414 may store reconstructed blocks to DPB 418. In examples where operations of filter unit 416 are performed, filter unit 416 may store the filtered reconstructed blocks to DPB 418. Motion estimation unit 422 and motion compensation unit 424 may retrieve a reference picture from DPB 418, formed from the reconstructed (and potentially filtered) blocks, to inter-predict blocks of subsequently encoded pictures. In addition, NN intra-prediction unit 426 may use reconstructed blocks in DPB 418 of a current picture to intra-predict other blocks in the current picture.

In general, entropy encoding unit 420 may entropy encode syntax elements received from other functional components of video encoder 400. For example, entropy encoding unit 420 may entropy encode quantized transform coefficient blocks from quantization unit 408. As another example, entropy encoding unit 420 may entropy encode prediction syntax elements (e.g., motion information for inter-prediction or intra-mode information for intra-prediction) from mode selection unit 402. Entropy encoding unit 420 may perform one or more entropy encoding operations on the syntax elements, which are another example of video data, to generate entropy-encoded data. For example, entropy encoding unit 420 may perform a context-adaptive variable length coding (CAVLC) operation, a CABAC operation, a variable-to-variable (V2V) length coding operation, a syntax-based context-adaptive binary arithmetic coding (SBAC) operation, a Probability Interval Partitioning Entropy (PIPE) coding operation, an Exponential-Golomb encoding operation, or another type of entropy encoding operation on the data. In some examples, entropy encoding unit 420 may operate in bypass mode where syntax elements are not entropy encoded.

Video encoder 400 may output a bitstream that includes the entropy encoded syntax elements needed to reconstruct blocks of a slice or picture. In particular, entropy encoding unit 420 may output the bitstream.

In accordance with AV1, entropy encoding unit 420 may be configured as a symbol-to-symbol adaptive multi-symbol arithmetic coder. A syntax element in AV1 includes an alphabet of N elements, and a context (e.g., probability model) includes a set of N probabilities. Entropy encoding unit 420 may store the probabilities as n-bit (e.g., 15-bit) cumulative distribution functions (CDFs). Entropy encoding unit 420 may perform recursive scaling, with an update factor based on the alphabet size, to update the contexts.

The operations described above are described with respect to a block. Such description should be understood as being operations for a luma coding block and/or chroma coding blocks. As described above, in some examples, the luma coding block and chroma coding blocks are luma and chroma components of a CU. In some examples, the luma coding block and the chroma coding blocks are luma and chroma components of a PU.

In some examples, operations performed with respect to a luma coding block need not be repeated for the chroma coding blocks. As one example, operations to identify a motion vector (MV) and reference picture for a luma coding block need not be repeated for identifying a MV and reference picture for the chroma blocks. Rather, the MV for the luma coding block may be scaled to determine the MV for the chroma blocks, and the reference picture may be the same. As another example, the intra-prediction process may be the same for the luma coding block and the chroma coding blocks.

In this manner, video encoder 400 represents an example of a device for decoding (after encoding) video data, including a memory configured to store video data; and a processing system comprising one or more processors implemented in circuitry, the processing system being configured to: generate a prediction block for a current block of the video data using a neural network; determine an equivalent intra mode for the prediction block from a set of available intra-prediction modes using decoder-side intra mode derivation (DIMD), the equivalent intra mode representing one of the intra-prediction modes that would generate an intra-prediction block that would best match the prediction block generated using the neural network; decode a residual block for the current block of the video data based on the equivalent intra mode; and combine the prediction block with the residual block to decode the current block of the video data. In particular, while video encoder 400 may generally be configured to encode video data to form an encoded video bitstream, video encoder 400 also includes reconstruction unit 414, inverse quantization unit 410, inverse transform processing unit 412, filter unit 416, DIMD unit 428, mode selection unit 402, and decoded picture buffer 418, which are configured to decode previously encoded video data for use as prediction data to predict subsequent video data, e.g., for encoding and decoding.

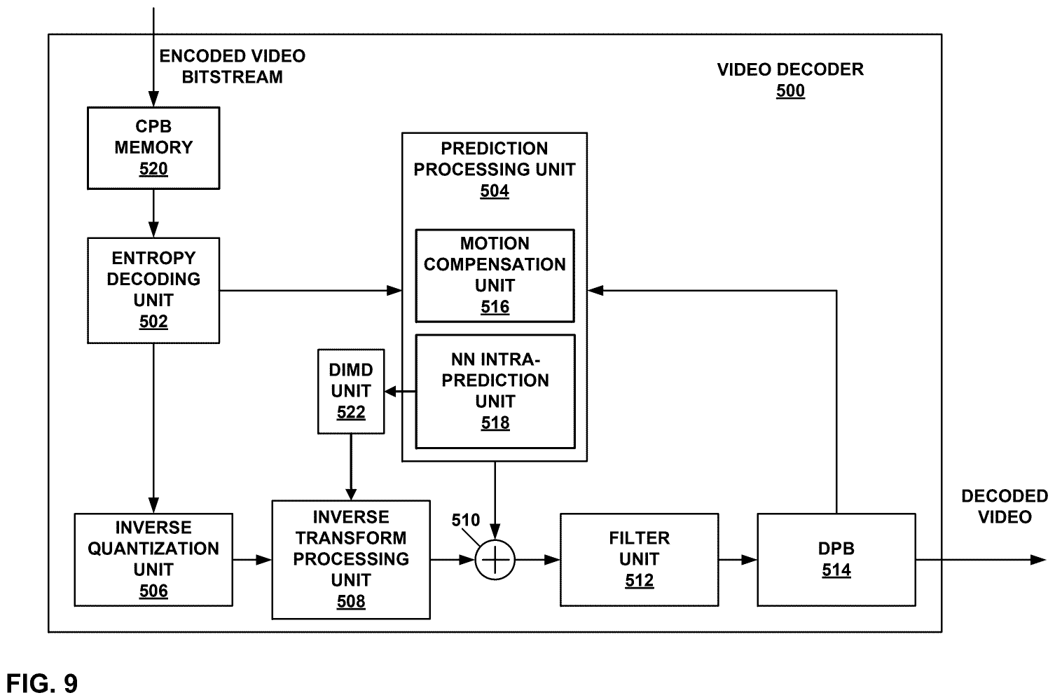

FIG. 9 is a block diagram illustrating example video decoder 500 per techniques of this disclosure. Video decoder 500 may be used in place of video decoder 300 in destination device 116 of FIG. 1. FIG. 9 is provided for purposes of explanation and is not limiting on the techniques as broadly exemplified and described in this disclosure. For purposes of explanation, this disclosure describes video decoder 500 according to the techniques of VVC (ITU-T H.266) and HEVC (ITU-T H.265). However, the techniques of this disclosure may be performed by video coding devices that are configured to other video coding standards.

In the example of FIG. 9, video decoder 500 includes coded picture buffer (CPB) memory 520, entropy decoding unit 502, prediction processing unit 504, DIMD unit 522, inverse quantization unit 506, inverse transform processing unit 508, reconstruction unit 510, filter unit 512, and decoded picture buffer (DPB) 514. Any or all of CPB memory 520, entropy decoding unit 502, prediction processing unit 504, DIMD unit 522, inverse quantization unit 506, inverse transform processing unit 508, reconstruction unit 510, filter unit 512, and DPB 514 may be implemented in one or more processors or in processing circuitry. For instance, the units of video decoder 500 may be implemented as one or more circuits or logic elements as part of hardware circuitry, or as part of a processor, ASIC, or FPGA. Moreover, video decoder 500 may include additional or alternative processors or processing circuitry to perform these and other functions.

Prediction processing unit 504 includes motion compensation unit 516 and neural network (NN) intra-prediction unit 518. Prediction processing unit 504 may include additional units to perform prediction in accordance with other prediction modes. As examples, prediction processing unit 504 may include a palette unit, an intra-block copy unit (which may form part of motion compensation unit 516), an affine unit, a linear model (LM) unit, or the like. In other examples, video decoder 500 may include more, fewer, or different functional components.

When operating according to AV1, motion compensation unit 516 may be configured to decode coding blocks of video data (e.g., both luma and chroma coding blocks) using translational motion compensation, affine motion compensation, OBMC, and/or compound inter-intra prediction, as described above. NN intra-prediction unit 518 may be configured to generate intra-prediction blocks for coding blocks of video data (e.g., both luma and chroma coding blocks) using a NN model, e.g., as discussed with respect to FIG. 3.

CPB memory 520 is an example of a memory system that may store video data, such as an encoded video bitstream, to be decoded by the components of video decoder 500. The video data stored in CPB memory 520 may be obtained, for example, from computer-readable medium 110 (FIG. 1). CPB memory 520 may include a CPB that stores encoded video data (e.g., syntax elements) from an encoded video bitstream. Also, CPB memory 520 may store video data other than syntax elements of a coded picture, such as temporary data representing outputs from the various units of video decoder 500. DPB 514 is an example of a memory system that generally stores decoded pictures, which video decoder 500 may output and/or use as reference video data when decoding subsequent data or pictures of the encoded video bitstream. CPB memory 520 and DPB 514 may be formed by any of a variety of memory devices, such as dynamic random access memory (DRAM), including synchronous DRAM (SDRAM), magnetoresistive RAM (MRAM), resistive RAM (RRAM), or other types of memory devices. CPB memory 520 and DPB 514 may each be provided by the same memory device or separate memory devices or memory units. In various examples, CPB memory 520 may be on-chip with other components of video decoder 500, or off-chip relative to those components.

Additionally or alternatively, in some examples, video decoder 500 may retrieve coded video data from memory 120 (FIG. 1). That is, memory 120 may store data as discussed above with CPB memory 520. Likewise, memory 120 may store instructions to be executed by video decoder 500, when some or all of the functionality of video decoder 500 is implemented in software to be executed by processing circuitry of video decoder 500.

The various units shown in FIG. 9 are illustrated to assist with understanding the operations performed by video decoder 500. The units may be implemented as fixed-function circuits, programmable circuits, or a combination thereof. Similar to FIG. 4, fixed-function circuits refer to circuits that provide particular functionality, and are preset on the operations that can be performed. Programmable circuits refer to circuits that can be programmed to perform various tasks, and provide flexible functionality in the operations that can be performed. For instance, programmable circuits may execute software or firmware that cause the programmable circuits to operate in the manner defined by instructions of the software or firmware. Fixed-function circuits may execute software instructions (e.g., to receive parameters or output parameters), but the types of operations that the fixed-function circuits perform are generally immutable. In some examples, one or more of the units may be distinct circuit blocks (fixed-function or programmable), and in some examples, one or more of the units may be integrated circuits.

Video decoder 500 may include ALUs, EFUs, digital circuits, analog circuits, and/or programmable cores formed from programmable circuits. In examples where the operations of video decoder 500 are performed by software executing on the programmable circuits, on-chip or off-chip memory may store instructions (e.g., object code) of the software that video decoder 500 receives and executes.

Entropy decoding unit 502 may receive encoded video data from the CPB and entropy decode the video data to reproduce syntax elements. Prediction processing unit 504, inverse quantization unit 506, inverse transform processing unit 508, reconstruction unit 510, and filter unit 512 may generate decoded video data based on the syntax elements extracted from the bitstream.

In general, video decoder 500 reconstructs a picture on a block-by-block basis. Video decoder 500 may perform a reconstruction operation on each block individually (where the block currently being reconstructed, i.e., decoded, may be referred to as a “current block”).

Entropy decoding unit 502 may entropy decode syntax elements defining quantized transform coefficients of a quantized transform coefficient block, as well as transform information, such as a quantization parameter (QP) and/or transform mode indication(s). Inverse quantization unit 506 may use the QP associated with the quantized transform coefficient block to determine a degree of quantization and, likewise, a degree of inverse quantization for inverse quantization unit 506 to apply. Inverse quantization unit 506 may, for example, perform a bitwise left-shift operation to inverse quantize the quantized transform coefficients. Inverse quantization unit 506 may thereby form a transform coefficient block including transform coefficients.

After inverse quantization unit 506 forms the transform coefficient block, inverse transform processing unit 508 may apply one or more inverse transforms to the transform coefficient block to generate a residual block associated with the current block. For example, inverse transform processing unit 508 may apply an inverse DCT, an inverse integer transform, an inverse Karhunen-Loeve transform (KLT), an inverse rotational transform, an inverse directional transform, or another inverse transform to the transform coefficient block.

Per techniques of this disclosure, inverse transform processing unit 508 may select one or more inverse transforms to apply to a transform block corresponding to a NN intra-predicted block according to an equivalent intra-prediction mode for the NN intra-predicted block. For example, inverse transform processing unit 508 may select an inverse multi-transform selection (MTS) to which the equivalent intra-prediction mode is mapped and apply the inverse MTS to the transform block to reconstruct the residual block. Alternatively, inverse transform processing unit 508 may select an inverse low-frequency non-separable transform (LFNST) and/or an inverse non-separable primary transform (NSPT) to which the equivalent intra-prediction mode is mapped and apply the inverse LFNST and/or inverse NSPT to the transform block to reconstruct the residual block.

Furthermore, prediction processing unit 504 generates a prediction block according to prediction information syntax elements that were entropy decoded by entropy decoding unit 502. For example, if the prediction information syntax elements indicate that the current block is inter-predicted, motion compensation unit 516 may generate the prediction block. In this case, the prediction information syntax elements may indicate a reference picture in DPB 514 from which to retrieve a reference block, as well as a motion vector identifying a location of the reference block in the reference picture relative to the location of the current block in the current picture. Motion compensation unit 516 may generally perform the inter-prediction process in a manner that is substantially similar to that described with respect to motion compensation unit 224 (FIG. 4).

As another example, if the prediction information syntax elements indicate that the current block is intra-predicted, NN intra-prediction unit 518 may generate the prediction block according to a NN model, which may correspond to a width and height of the block, e.g., as discussed above with respect to FIG. 3. NN intra-prediction unit 518 may retrieve data of neighboring samples to the current block from DPB 514.

DIMD unit 522 may determine an equivalent intra-prediction mode for a prediction block formed by NN intra-prediction unit 518. For example, DIMD unit 522 may determine which of the intra-prediction modes of FIG. 2 that, if used to form an intra-prediction block, would most closely match the prediction block generated by NN intra-prediction unit 518. To determine the equivalent intra-prediction mode, DIMD unit 522 may calculate gradients for samples of the prediction block formed by NN intra-prediction unit 518. DIMD unit 522 may then calculate a histogram from the gradients. For example, each gradient may correspond to an entry in the histogram, and each entry in the histogram may have a value corresponding to a number of times the corresponding gradient occurs in the prediction block formed by NN intra-prediction unit 518. DIMD unit 522 may then determine which of the gradients has the greatest value in the histogram and, thus, determine which of the intra-prediction modes (e.g., of FIG. 2) best corresponds to the histogram. DIMD unit 522 may then provide data representing the equivalent intra-prediction mode to inverse transform processing unit 508.

In some examples, DIMD unit 522 may perform DIMD for NN intra-predicted blocks of all block shapes supported by NN-based derived prediction.

In some examples, DIMD unit 522 may perform DIMD on a NN-intra predicted block prior to upsampling. For example, if a current block is 64×64 and NN intra-prediction unit 518 generates a 16×16 intra-prediction block, DIMD unit 522 may perform DIMD on the 16×16 intra-prediction block, and then video decoder 500 may upsample the 16×16 intra-prediction block to a 64×64 block.

In some examples, video decoder 500 may support both DIMD and NN-based equivalent mode derivation. Video decoder 500 may select between DIMD unit 522 and a NN-based equivalent mode derivation unit based on various criteria, e.g., block size. For example, DIMD may be used for intra-prediction blocks not requiring upsampling, and NN-based equivalent mode derivation may be used for intra-prediction blocks requiring upsampling. As another example, DIMD may be used for relatively small intra-prediction blocks, e.g., up to 8×8, and NN-based equivalent mode derivation may be used for blocks having sizes larger than 8×8.

Reconstruction unit 510 may reconstruct the current block using the prediction block and the residual block. For example, reconstruction unit 510 may add samples of the residual block to corresponding samples of the prediction block to reconstruct the current block.

Filter unit 512 may perform one or more filter operations on reconstructed blocks. For example, filter unit 512 may perform deblocking operations to reduce blockiness artifacts along edges of the reconstructed blocks. Operations of filter unit 512 are not necessarily performed in all examples.

Video decoder 500 may store the reconstructed blocks in DPB 514. For instance, in examples where operations of filter unit 512 are not performed, reconstruction unit 510 may store reconstructed blocks to DPB 514. In examples where operations of filter unit 512 are performed, filter unit 512 may store the filtered reconstructed blocks to DPB 514. As discussed above, DPB 514 may provide reference information, such as samples of a current picture for intra-prediction and previously decoded pictures for subsequent motion compensation, to prediction processing unit 504. Moreover, video decoder 500 may output decoded pictures (e.g., decoded video) from DPB 514 for subsequent presentation on a display device, such as display device 118 of FIG. 1.

In this manner, video decoder 500 represents an example of a device for decoding video data, including a memory configured to store video data; and a processing system comprising one or more processors implemented in circuitry, the processing system being configured to: generate a prediction block for a current block of the video data using a neural network; determine an equivalent intra mode for the prediction block from a set of available intra-prediction modes using decoder-side intra mode derivation (DIMD), the equivalent intra mode representing one of the intra-prediction modes that would generate an intra-prediction block that would best match the prediction block generated using the neural network; decode a residual block for the current block of the video data based on the equivalent intra mode; and combine the prediction block with the residual block to decode the current block of the video data.

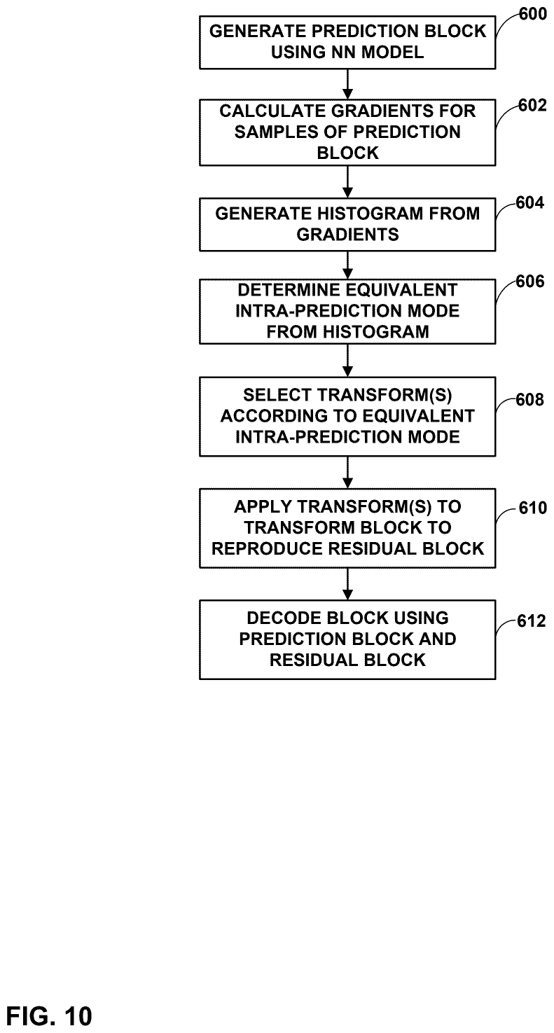

FIG. 10 is a flowchart illustrating an example method of decoding a block of video data according to techniques of this disclosure. Video encoder 400 and/or video decoder 500, or other video coding devices, may be configured to perform the method of FIG. 10. For purposes of example and explanation, the method of FIG. 10 is explained with respect to video decoder 500 of FIG. 9.

Initially, video decoder 500 may generate a prediction block using a NN model (600). For example, video decoder 500 may determine that a block of video data is to be intra-predicted using NN intra-prediction. Video decoder 500 may determine a size of the block, e.g., a width and a height of the block, and select a corresponding NN model based on the width and the height of the block, e.g., as discussed above with respect to FIG. 3. Video decoder 500 may then use the selected NN model to generate a prediction block.

Video decoder 500 may then calculate gradients for samples of the prediction block (602). Video decoder 500 may also generate a histogram from the gradients (604). Video decoder 500 may then determine an equivalent intra-prediction mode from the histogram (606). For example, video decoder 500 may determine which intra-prediction mode of a set of possible intra-prediction modes would generate an intra-prediction block that best matches the intra-prediction block generated using the NN model. Rather than actually generating intra-prediction blocks using all or a subset of the intra-prediction modes, however, calculating the gradients and generating the histogram of the gradients may be used to determine which of the intra-prediction modes (e.g., of FIG. 2) would most likely generate a prediction block that best matches the intra-prediction block generated using the NN model.

Video decoder 500 may then select one or more inverse transforms according to the equivalent intra-prediction mode (608). For example, video decoder 500 may select an MTS scheme, e.g., including two transform kernels, to be applied to a transform block to reconstruct a residual block. As another example, video decoder 500 may select an inverse LFNST and/or an inverse NSPT according to the equivalent intra-prediction mode.

Video decoder 500 may further decode quantized transform coefficients and perform an inverse scan to place the quantized transform coefficients in appropriate positions in the transform block. Video decoder 500 may also inverse quantize the quantized transform coefficients to reconstruct the transform coefficients in the transform block. Video decoder 500 may then apply the selected inverse transform(s) to the transform block to reproduce the residual block (610).

Video decoder 500 may then decode the current block using the prediction block and the residual block (612). For example, video decoder 500 may add each co-located sample of the prediction block and of the residual block to reconstruct the block.

Although the example of transform selection based on the equivalent intra-prediction mode is presented in FIG. 10, in other examples, additional and/or alternative residual coding processes may be performed based on the equivalent intra-prediction mode. For example, a scan order may be selected based on the equivalent intra-prediction mode, where the scan order corresponds to an order in which quantized transform coefficients extracted from the encoded bitstream are placed into a transform block (e.g., horizontal scan, vertical scan, zig-zag scan, or other fixed or dynamic scan orders). As another example, contexts for context-based decoding (e.g., CABAC decoding) the quantized transform coefficients may be selected based at least in part on the equivalent intra-prediction mode.

In this manner, the method of FIG. 10 represents an example of a method of decoding video data, including generating a prediction block for a current block of video data using a neural network; determining an equivalent intra mode for the prediction block from a set of available intra-prediction modes using decoder-side intra mode derivation (DIMD), the equivalent intra mode representing one of the intra-prediction modes that would generate an intra-prediction block that would best match the prediction block generated using the neural network; decoding a residual block for the current block of the video data based on the equivalent intra mode; and combining the prediction block with the residual block to decode the current block of the video data.

The following clauses represent various examples of the techniques of this disclosure:
Clause 1: A method of decoding video data, the method comprising: determining an equivalent intra mode of a current block of video data using decoder-side intra mode derivation (DIMD); generating a prediction block for the current block of the video data; decoding a residual block for the current block of the video data; and combining the prediction block with the residual block to decode the current block of the video data.
Clause 2: The method of clause 1, wherein determining the equivalent intra mode comprises applying DIMD to the prediction block to determine the equivalent intra mode.
Clause 3: The method of any of clauses 1 and 2, wherein determining the equivalent intra mode comprises determining the equivalent intra mode prior to upsampling
Clause 4: The method of any of clauses 1-3, further comprising selecting DIMD from a set of available derivation modes including DIMD and neural network (NN)-based derivation modes.
Clause 5: The method of any of clauses 1 and 2, further comprising determining that the current block does not require upsampling.
Clause 6: The method of any of clauses 1-5, further comprising determining that the current block has a size of 8×8 or smaller.
Clause 7: The method of any of clauses 1-6, further comprising encoding the current block prior to decoding the current block.
Clause 8: A device for decoding video data, the device comprising one or more means for performing the method of any of clauses 1-7.
Clause 9: The device of clause 8, further comprising a display configured to display the decoded video data.
Clause 10: The device of any of clauses 8 and 9, wherein the device comprises one or more of a camera, a computer, a mobile device, a broadcast receiver device, or a set-top box.
Clause 11: The device of any of clauses 8-10, further comprising a memory configured to store the video data.
Clause 12: A computer-readable storage medium having stored thereon instructions that, when executed, cause a processor of a device for decoding video data to perform the method of any of clauses 1-7.
Clause 13: A device for decoding video data, the device comprising: means for determining an equivalent intra mode of a current block of video data using decoder-side intra mode derivation (DIMD); means for generating a prediction block for the current block of the video data; means for decoding a residual block for the current block of the video data; and means for combining the prediction block with the residual block to decode the current block of the video data.
Clause 14: A method of decoding video data, the method comprising: generating a prediction block for a current block of video data using a neural network; determining an equivalent intra mode for the prediction block from a set of available intra-prediction modes using decoder-side intra mode derivation (DIMD), the equivalent intra mode representing one of the intra-prediction modes that would generate an intra-prediction block that would best match the prediction block generated using the neural network; decoding a residual block for the current block of the video data based on the equivalent intra mode; and combining the prediction block with the residual block to decode the current block of the video data.
Clause 15: The method of clause 14, wherein determining the equivalent intra mode comprises: calculating gradients for samples of the prediction block; generating a histogram using the gradients; and determining the equivalent intra mode according to the histogram.
Clause 16: The method of clause 14, wherein decoding the residual block comprises: decoding transform coefficients of a transform block for the current block; determining one or more transforms to apply to the transform block according to the equivalent intra-prediction mode; and applying the one or more transforms to the transform block to reconstruct the residual block.
Clause 17: The method of clause 14, wherein decoding the residual block comprises: determining a multiple transform selection (MTS) according to the equivalent intra mode; and applying the MTS to a transform block to reconstruct the residual block.
Clause 18: The method of clause 14, wherein decoding the residual block comprises: determining a low-frequency non-separable transform (LFNST) according to the equivalent intra mode; and applying the LFNST to a transform block to reconstruct the residual block.
Clause 19: The method of clause 14, wherein determining the equivalent intra mode comprises determining the equivalent intra mode prior to upsampling the prediction block to a size of the residual block.
Clause 20: The method of clause 14, further comprising selecting DIMD from a set of available derivation modes including DIMD and neural network (NN)-based derivation modes.
Clause 21: The method of clause 14, further comprising determining that the prediction block does not require upsampling.
Clause 22: The method of clause 14, further comprising determining that the current block has a size of 8×8 or smaller.
Clause 23: The method of clause 14, further comprising encoding the current block prior to decoding the current block.
Clause 24: A device for decoding video data, the device comprising: a memory configured to store video data; and a processing system comprising one or more processors implemented in circuitry, the processing system being configured to: generate a prediction block for a current block of the video data using a neural network; determine an equivalent intra mode for the prediction block from a set of available intra-prediction modes using decoder-side intra mode derivation (DIMD), the equivalent intra mode representing one of the intra-prediction modes that would generate an intra-prediction block that would best match the prediction block generated using the neural network; decode a residual block for the current block of the video data based on the equivalent intra mode; and combine the prediction block with the residual block to decode the current block of the video data.
Clause 25: The device of clause 24, wherein to determine the equivalent intra mode, the processing system is configured to: calculate gradients for samples of the prediction block; generate a histogram using the gradients; and determine the equivalent intra mode according to the histogram.
Clause 26: The device of clause 24, wherein to decode the residual block, the processing system is configured to: determine a multiple transform selection (MTS) according to the equivalent intra mode; and apply the MTS to a transform block to reconstruct the residual block.
Clause 27: The device of clause 24, wherein to decode the residual block, the processing system is configured to: determine a low-frequency non-separable transform (LFNST) according to the equivalent intra mode; and apply the LFNST to a transform block to reconstruct the residual block.
Clause 28: The device of clause 24, wherein the processing system is configured to determine the equivalent intra mode prior to upsampling the prediction block to a size of the residual block.
Clause 29: The device of clause 24, wherein the processing system is further configured to select DIMD from a set of available derivation modes including DIMD and neural network (NN)-based derivation modes.
Clause 30: The device of clause 24, wherein the processing system is further configured to determine that the prediction block does not require upsampling.
Clause 31: The device of clause 24, wherein the processing system is further configured to determine that the current block has a size of 8×8 or smaller.
Clause 32: The device of clause 24, wherein the processing system is further configured to encode the current block prior to decoding the current block.
Clause 33: The device of clause 24, further comprising a display configured to display the decoded video data.
Clause 34: The device of clause 24, wherein the device comprises one or more of a camera, a computer, a mobile device, a broadcast receiver device, or a set-top box.
Clause 35: A device for decoding video data, the device comprising: means for generating a prediction block for a current block of video data using a neural network; means for determining an equivalent intra mode for the prediction block from a set of available intra-prediction modes using decoder-side intra mode derivation (DIMD), the equivalent intra mode representing one of the intra-prediction modes that would generate an intra-prediction block that would best match the prediction block generated using the neural network; means for decoding a residual block for the current block of the video data based on the equivalent intra mode; and means for combining the prediction block with the residual block to decode the current block of the video data.
Clause 36: The device of clause 35, wherein the means for determining the equivalent intra mode comprises: means for calculating gradients for samples of the prediction block; means for generating a histogram using the gradients; and means for determining the equivalent intra mode according to the histogram.
Clause 37: The device of clause 35, wherein the means for decoding the residual block comprises: means for decoding transform coefficients of a transform block for the current block; means for determining one or more transforms to apply to the transform block according to the equivalent intra-prediction mode; and means for applying the one or more transforms to the transform block to reconstruct the residual block.
Clause 38: The device of clause 35, wherein the means for decoding the residual block comprises: means for determining a multiple transform selection (MTS) according to the equivalent intra mode; and means for applying the MTS to a transform block to reconstruct the residual block.
Clause 39: The device of clause 35, wherein the means for decoding the residual block comprises: means for determining a low-frequency non-separable transform (LFNST) according to the equivalent intra mode; and means for applying the LFNST to a transform block to reconstruct the residual block.
Clause 40: The device of clause 35, wherein the means for determining the equivalent intra mode comprises means for determining the equivalent intra mode prior to upsampling the prediction block to a size of the residual block.
Clause 41: The device of clause 35, further comprising means for selecting DIMD from a set of available derivation modes including DIMD and neural network (NN)-based derivation modes.
Clause 42: The device of clause 35, further comprising means for determining that the prediction block does not require upsampling.
Clause 43: The device of clause 35, further comprising means for determining that the current block has a size of 8×8 or smaller.
Clause 44: The device of clause 35, further comprising means for encoding the current block prior to decoding the current block.
Clause 45: A method of decoding video data, the method comprising: generating a prediction block for a current block of video data using a neural network; determining an equivalent intra mode for the prediction block from a set of available intra-prediction modes using decoder-side intra mode derivation (DIMD), the equivalent intra mode representing one of the intra-prediction modes that would generate an intra-prediction block that would best match the prediction block generated using the neural network; decoding a residual block for the current block of the video data based on the equivalent intra mode; and combining the prediction block with the residual block to decode the current block of the video data.
Clause 46: The method of clause 45, wherein determining the equivalent intra mode comprises: calculating gradients for samples of the prediction block; generating a histogram using the gradients; and determining the equivalent intra mode according to the histogram.
Clause 47: The method of any of clauses 45 and 46, wherein decoding the residual block comprises: decoding transform coefficients of a transform block for the current block; determining one or more transforms to apply to the transform block according to the equivalent intra-prediction mode; and applying the one or more transforms to the transform block to reconstruct the residual block.
Clause 48: The method of any of clauses 45-47, wherein decoding the residual block comprises: determining a multiple transform selection (MTS) according to the equivalent intra mode; and applying the MTS to a transform block to reconstruct the residual block.
Clause 49: The method of any of clauses 45-47, wherein decoding the residual block comprises: determining a low-frequency non-separable transform (LFNST) according to the equivalent intra mode; and applying the LFNST to a transform block to reconstruct the residual block.
Clause 50: The method of any of clauses 45-49, wherein determining the equivalent intra mode comprises determining the equivalent intra mode prior to upsampling the prediction block to a size of the residual block.
Clause 51: The method of any of clauses 45-49, further comprising determining that the prediction block does not require upsampling.
Clause 52: The method of any of clauses 45-51, further comprising selecting DIMD from a set of available derivation modes including DIMD and neural network (NN)-based derivation modes.
Clause 53: The method of any of clauses 45-52, further comprising determining that the current block has a size of 8×8 or smaller.
Clause 54: The method of any of clauses 45-53, further comprising encoding the current block prior to decoding the current block.
Clause 55: A device for decoding video data, the device comprising: a memory configured to store video data; and a processing system comprising one or more processors implemented in circuitry, the processing system being configured to: generate a prediction block for a current block of the video data using a neural network; determine an equivalent intra mode for the prediction block from a set of available intra-prediction modes using decoder-side intra mode derivation (DIMD), the equivalent intra mode representing one of the intra-prediction modes that would generate an intra-prediction block that would best match the prediction block generated using the neural network; decode a residual block for the current block of the video data based on the equivalent intra mode; and combine the prediction block with the residual block to decode the current block of the video data.
Clause 56: The device of clause 55, wherein to determine the equivalent intra mode, the processing system is configured to: calculate gradients for samples of the prediction block; generate a histogram using the gradients; and determine the equivalent intra mode according to the histogram.
Clause 57: The device of any of clauses 55 and 56, wherein to decode the residual block, the processing system is configured to: determine a multiple transform selection (MTS) according to the equivalent intra mode; and apply the MTS to a transform block to reconstruct the residual block.
Clause 58: The device of any of clauses 55 and 56, wherein to decode the residual block, the processing system is configured to: determine a low-frequency non-separable transform (LFNST) according to the equivalent intra mode; and apply the LFNST to a transform block to reconstruct the residual block.
Clause 59: The device of any of clauses 55-58, wherein the processing system is configured to determine the equivalent intra mode prior to upsampling the prediction block to a size of the residual block.
Clause 60: The device of any of clauses 55-58, wherein the processing system is further configured to determine that the prediction block does not require upsampling.
Clause 61: The device of any of clauses 55-60, wherein the processing system is further configured to select DIMD from a set of available derivation modes including DIMD and neural network (NN)-based derivation modes.
Clause 62: The device of any of clauses 55-61, wherein the processing system is further configured to determine that the current block has a size of 8×8 or smaller.
Clause 63: The device of any of clauses 55-62, wherein the processing system is further configured to encode the current block prior to decoding the current block.
Clause 64: The device of any of clauses 55-63, further comprising a display configured to display the decoded video data.
Clause 65: The device of any of clauses 55-64, wherein the device comprises one or more of a camera, a computer, a mobile device, a broadcast receiver device, or a set-top box.
Clause 66: A device for decoding video data, the device comprising: means for generating a prediction block for a current block of video data using a neural network; means for determining an equivalent intra mode for the prediction block from a set of available intra-prediction modes using decoder-side intra mode derivation (DIMD), the equivalent intra mode representing one of the intra-prediction modes that would generate an intra-prediction block that would best match the prediction block generated using the neural network; means for decoding a residual block for the current block of the video data based on the equivalent intra mode; and means for combining the prediction block with the residual block to decode the current block of the video data.
Clause 67: The device of clause 66, wherein the means for determining the equivalent intra mode comprises: means for calculating gradients for samples of the prediction block; means for generating a histogram using the gradients; and means for determining the equivalent intra mode according to the histogram.
Clause 68: The device of any of clauses 66 and 67, wherein the means for decoding the residual block comprises: means for decoding transform coefficients of a transform block for the current block; means for determining one or more transforms to apply to the transform block according to the equivalent intra-prediction mode; and means for applying the one or more transforms to the transform block to reconstruct the residual block.
Clause 69: The device of any of clauses 66-68, wherein the means for decoding the residual block comprises: means for determining a multiple transform selection (MTS) according to the equivalent intra mode; and means for applying the MTS to a transform block to reconstruct the residual block.
Clause 70: The device of any of clauses 66-68, wherein the means for decoding the residual block comprises: means for determining a low-frequency non-separable transform (LFNST) according to the equivalent intra mode; and means for applying the LFNST to a transform block to reconstruct the residual block.
Clause 71: The device of any of clauses 66-70, wherein the means for determining the equivalent intra mode comprises means for determining the equivalent intra mode prior to upsampling the prediction block to a size of the residual block.
Clause 72: The device of any of clauses 66-70, further comprising means for determining that the prediction block does not require upsampling.
Clause 73: The device of any of clauses 66-72, further comprising means for selecting DIMD from a set of available derivation modes including DIMD and neural network (NN)-based derivation modes.
Clause 74: The device of any of clauses 66-73, further comprising means for determining that the current block has a size of 8×8 or smaller.
Clause 75: The device of any of clauses 66-74, further comprising means for encoding the current block prior to decoding the current block.

It is to be recognized that depending on the example, certain acts or events of any of the techniques described herein can be performed in a different sequence, may be added, merged, or left out altogether (e.g., not all described acts or events are necessary for the practice of the techniques). Moreover, in certain examples, acts or events may be performed concurrently, e.g., through multi-threaded processing, interrupt processing, or multiple processors, rather than sequentially.

In one or more examples, the functions described may be implemented in hardware, software, firmware, or any combination thereof. If implemented in software, the functions may be stored on or transmitted over as one or more instructions or code on a computer-readable medium and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media can include RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transitory media, but are instead directed to non-transitory, tangible storage media. Disk and disc, as used herein, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Instructions may be executed by one or more processors, such as one or more digital signal processors (DSPs), general purpose microprocessors, application specific integrated circuits (ASICs), field programmable gate arrays (FPGAs), or other equivalent integrated or discrete logic circuitry. Accordingly, the terms “processor” and “processing circuitry,” as used herein may refer to any of the foregoing structures or any other structure suitable for implementation of the techniques described herein. In addition, in some aspects, the functionality described herein may be provided within dedicated hardware and/or software modules configured for encoding and decoding, or incorporated in a combined codec. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a codec hardware unit or provided by a collection of interoperative hardware units, including one or more processors as described above, in conjunction with suitable software and/or firmware.

Various examples have been described. These and other examples are within the scope of the following claims.

What is claimed is:

1. A method of decoding video data, the method comprising:
generating a prediction block for a current block of video data using a neural network;
determining an equivalent intra mode for the prediction block from a set of available intra-prediction modes using decoder-side intra mode derivation (DIMD), the equivalent intra mode representing one of the available intra-prediction modes that would generate an intra-prediction block that would best match the prediction block generated using the neural network;
decoding a residual block for the current block of the video data based on the equivalent intra mode; and
combining the prediction block with the residual block to decode the current block of the video data.

2. The method of claim 1, wherein determining the equivalent intra mode comprises:
calculating gradients for samples of the prediction block;
generating a histogram using the gradients; and
determining the equivalent intra mode according to the histogram.

3. The method of claim 1, wherein decoding the residual block comprises:
determining a multiple transform selection (MTS) according to the equivalent intra mode; and
applying the MTS to a transform block to reconstruct the residual block.

4. The method of claim 1, wherein decoding the residual block comprises:
determining a low-frequency non-separable transform (LFNST) according to the equivalent intra mode; and
applying the LFNST to a transform block to reconstruct the residual block.

5. The method of claim 1, wherein determining the equivalent intra mode comprises determining the equivalent intra mode prior to upsampling the prediction block to a size of the residual block.

6. The method of claim 1, further comprising selecting DIMD from a set of available derivation modes including DIMD and neural network (NN)-based derivation modes.

7. The method of claim 1, further comprising determining that the prediction block does not require upsampling.

8. The method of claim 1, further comprising determining that the current block has a size of 8×8 or smaller.

9. The method of claim 1, further comprising encoding the current block prior to decoding the current block.

10. A device for decoding video data, the device comprising:
a memory configured to store video data; and
a processing system comprising one or more processors implemented in circuitry, the processing system being configured to:
generate a prediction block for a current block of the video data using a neural network;
determine an equivalent intra mode for the prediction block from a set of available intra-prediction modes using decoder-side intra mode derivation (DIMD), the equivalent intra mode representing one of the available intra-prediction modes that would generate an intra-prediction block that would best match the prediction block generated using the neural network;
decode a residual block for the current block of the video data based on the equivalent intra mode; and
combine the prediction block with the residual block to decode the current block of the video data.

11. The device of claim 10, wherein to determine the equivalent intra mode, the processing system is configured to:
calculate gradients for samples of the prediction block;
generate a histogram using the gradients; and
determine the equivalent intra mode according to the histogram.

12. The device of claim 10, wherein to decode the residual block, the processing system is configured to:
determine a multiple transform selection (MTS) according to the equivalent intra mode; and
apply the MTS to a transform block to reconstruct the residual block.

13. The device of claim 10, wherein to decode the residual block, the processing system is configured to:
determine a low-frequency non-separable transform (LFNST) according to the equivalent intra mode; and
apply the LFNST to a transform block to reconstruct the residual block.

14. The device of claim 10, wherein the processing system is configured to determine the equivalent intra mode prior to upsampling the prediction block to a size of the residual block.

15. The device of claim 10, wherein the processing system is further configured to select DIMD from a set of available derivation modes including DIMD and neural network (NN)-based derivation modes.

16. The device of claim 10, wherein the processing system is further configured to determine that the current block has a size of 8×8 or smaller.

17. The device of claim 10, wherein the processing system is further configured to encode the current block prior to decoding the current block.

18. The device of claim 10, further comprising a display configured to display decoded video data.

19. The device of claim 10, wherein the device comprises one or more of a camera, a computer, a mobile device, a broadcast receiver device, or a set-top box.

20. A device for decoding video data, the device comprising:
means for generating a prediction block for a current block of video data using a neural network;
means for determining an equivalent intra mode for the prediction block from a set of available intra-prediction modes using decoder-side intra mode derivation (DIMD), the equivalent intra mode representing one of the available intra-prediction modes that would generate an intra-prediction block that would best match the prediction block generated using the neural network;
means for decoding a residual block for the current block of the video data based on the equivalent intra mode; and
means for combining the prediction block with the residual block to decode the current block of the video data.
